(19) United States
(12) Patent Application Publication
(10) Pub. No.: US 2016/0335653 A1
(43) Pub. Date: Nov. 17, 2016

(54) INCENTIVES ASSOCIATED WITH LINKED FINANCIAL ACCOUNTS

(71) Applicant: VISA U.S.A. INC., San Francisco, CA (US)

(72) Inventor: Shaun Bodington, San Leandro, CA (US)

(21) Appl. No.: 15/219,091

(22) Filed: Jul. 25, 2016

Related U.S. Application Data
(62) Division of application No. 12/688,653, filed on Jan. 15, 2010.
(60) Provisional application No. 61/145,010, filed on Jan. 15, 2009.

(51) Int. Cl. G06Q 30/02; G06Q 20/10

(52) U.S. Cl. CPC G06Q 30/0215; G06Q 30/0227; G06Q 20/102

(57) ABSTRACT

A set of accounts usable for cashless transactions are electronically linked together. The accounts in the set may be associated with different accountholders, issuers, financial institutions, transaction handlers, or combinations thereof. A stakeholder sets up rules that govern, in part, processing of cashless transactions upon the accounts in the set. The rules alter routing of the cashless transaction from one account to another in the set. Loyalty features are determined accordingly. In one implementation, the rule alters the routing of the cashless transaction to optimize a loyalty feature. Amounts spent in transactions upon the accounts in the account set may be tracked, analyzed or reported on to create targeted offers. Fulfillment of the targeted offers may be conditioned on validating that the actual spend upon the accounts in the set match a predetermined threshold.

### RELATED APPLICATIONS

The present application is a divisional application of U.S. patent application Ser. No. 12/688,653, filed Jan. 15, 2010, and entitled “INCENTIVES ASSOCIATED WITH LINKED FINANCIAL ACCOUNTS”, which claims the benefit of the filing date of Prov. U.S. Pat. App. Ser. No. 61/145,010, filed Jan. 15, 2009, entitled “Tailored Transaction Processing”, the entire disclosures of which applications are hereby incorporated herein by reference.

### FIELD

Various implementations, and combinations thereof, are related to processing of transactions, more particularly processing of payment transactions, and most particularly to processing of financial transactions upon corresponding accounts that are each associated with one another in a set of such accounts.

### BACKGROUND

Consumers and merchants engage in transactions (e.g., financial transactions) for resources, such as goods, services, or information. The transaction or “purchase” can be a sale, a lease, an assignment, or a license where some form of currency (e.g., money or “points” in a loyalty program) is exchanged for the resource. Alternatively, the transaction may also be gratuitous, such as a donation to a charitable organization, where the currency is not exchanged for a resource. Here, the consumer may be a person, an entity, or a group of persons or entities. The merchant may be, for example, a retailer, a wholesaler, a reseller, a manufacturer, a broker, a distributor, a provider, or any entity in the distribution chain of resources. In a business-to-business environment, a first merchant may be engaged in the transaction with the consumer that is a second such merchant, for instance a small business.

Transactions that are cashless may be electronically processed within a network or system through the use of an account such as: a checking account, a savings account, a prepay account, a flexible spending account, a health savings account, a credit account, a credit union account, a debit account, a Demand Deposit Account (DDA), an Automated Clearing House account, a Negotiable Order of Withdrawal account, a PayPal® account, a college deposit/student Identification account, or combinations thereof. For example, in a payment processing system, such as VisaNet® system, American Express® system, or the Veriphone® system, a transaction handler processes the transaction made payable upon the account that has been issued to the consumer (“accountholder”) by an issuer, such as a bank. The payment processing system may be an open, a closed, or a hybrid system, as is known in the art.

Traditionally, account features associated with accounts and the procedures for processing of transactions upon the accounts have been dictated by the industry, such as the financial services industry. For example, when a consumer swipes a credit card at a point of sale (POS) of a merchant, a transmission is formed including indicia about the transaction (e.g., merchant identifier, date, and amount of the transaction) and an account identifier (e.g., “a financial account identifier”) associated with the credit account. The first six digits of the account identifier (e.g., a Bank Identification Number (BIN)) typically facilitate routing of the transaction through the system to the corresponding issuer of the credit card for authorization of the transaction with the merchant.

Similarly, issuers of the accounts typically dictate the account features, or range of account features, of the corresponding accounts that the issuer is willing to make available to the consumers or the merchants in association with their respective accounts. Based on the type of account being issued, the issuer may offer such account features as: annual percentage rates, loyalty programs, fraud alerts, no preset spending limit, access to exclusive events, preferred dining reservation, loyalty programs, accountholder inquiry services, emergency card replacement, emergency cash disbursement, lost/stolen card reporting, zero accountholder liability toward fraudulent transactions, auto rental collision damage waiver, roadside dispatch, travel accident insurance, travel and emergency assistance service, legal counsel services, lost luggage reimbursement, purchase security, concierge services, dining discounts, warranty manager service, year-end summary statement, personal identity theft coverage, companion airline ticket, emergency evacuation and transportation insurance, emergency medical/dental coverage, hotel/motel burglary coverage, purchase extended warranty, or merchant offers, for example.

The account features offered with the account may depend upon profitability to the financial institution. For example, the financial institutions typically offer concierge access privileges for a credit product but not for a debit product because the financial institution may not receive revenues from the debit product that would off-set the costs for providing the concierge access privileges to a consumer that uses the debit account.

Consequently, many consumers obtain multiple accounts in an effort to meet their financial needs. For example, it is not unusual for consumers to carry multiple payment cards, from various financial institutions, in their wallets. However, management of multiple accounts may become cumbersome as each may have different expiration dates, billing cycles, and loyalty programs. Moreover, the consumer may be forced to use a particular account during a transaction if the consumer seeks to receive the corresponding associated account feature, such as loyalty points.

It would be an advantage to the art to provide account related services that guide the processing of transactions for accounts of accountholders.

### SUMMARY

Methods, apparatuses, and systems are disclosed wherein transaction processing among a set of accounts (“account set”) is tailored according to business rules set up, in part, by one or more stakeholders. The stakeholders may include: an accountholder, an accountholder, an issuer, a merchant, a transaction handler, an acquirer, or a combination thereof. Therefore, the transaction history upon the accounts in the account set is accessed or analyzed through the use of tools. Implementations for tailoring transaction processing based on the rules, or for access or analysis using the tools, may include associating accounts in the account set and applying the rules or tools across various: accounts, account types, accountholders, issuers, financial institutions, transaction handlers, or combinations thereof, for examples.

In one implementation, a system for conducting a financial transaction is disclosed. The system includes a memory storing a plurality account set identifiers that are each correlated to a set of financial accounts and a processor programmed to execute steps. The steps include receiving an authorization request for a financial transaction between a merchant and a consumer, the authorization request including a financial account identifier. The financial account identifier is compared with the account set identifiers to find a match. One of the financial account is selected, upon which apply the financial transaction, from the set of financial accounts corresponding to the matched account set identifier. The authorization request is routed to an issuer of the selected financial account. A transmission is formed for delivery to the merchant including the authorization response. The system facilitates providing a value of an incentive to an accountholder of one of the financial accounts in the set of financial accounts corresponding to the matched account set identifier. The incentive is associated with applying the financial transaction upon the selected financial account.

In another implementation, a computer device of a transaction handler (e.g. Visa) receives an authorization request including a financial account identifier. The computer device matches the received financial account identifier with an account set identifiers that correlated to a set of financial accounts. The computer device selects one of the accounts from the set of financial accounts by at least using a value of an incentive corresponding to applying the financial transaction to one or more financial accounts in the set of financial accounts. The computer device routes the authorization request to an issuer of the selected financial account. The computer device receives the authorization response and sends it to the merchant. The computer facilitates providing the value of the incentive, corresponding to applying the financial transaction to the selected financial account, to an accountholder of one of the financial accounts in the set of financial accounts.

In yet another implementation, a system for facilitating fulfillment of an incentive is disclosed. The system includes a memory storing data about a plurality of financial transactions and a processor. The stored data about each of the financial transactions includes a transaction amount and a date for the financial transaction. The processor receives a business rule for fulfillment of the incentive of a stakeholder conditioned on validating that a spend, over a duration of time, matches a criterion. The processor calculates the spend based on a combination of the transaction amounts of the financial transactions that occurred over the duration of time and validates that the calculated spend matches the criterion prior to facilitating the fulfillment of the incentive.

### BRIEF DESCRIPTION OF THE DRAWINGS

Implementations will become more apparent from the detailed description set forth below when taken in conjunction with the drawings, in which like elements bear like reference numerals.

FIG. 1 illustrates a block diagram of an exemplary system in which transaction processing upon a set of accounts may be tailored;

FIG. 2 illustrates a block diagram of an exemplary payment processing system that can operate within the environment of FIG. 1;

FIG. 3 depicts a flowchart of an exemplary process for associating accounts within an account set, creating rules, and using tools in the environment of FIG. 1;

FIGS. 4a-6b each depict user interfaces for data entry forms to link accounts in the environment of FIG. 1;

FIGS. 7a-7b depict user interfaces for rendering a list of tool options and selecting a report element;

FIG. 8 depicts a flowchart of an exemplary process for implementing rules that are defined in the environment of FIG. 1;

FIG. 9 depicts a flowchart of an exemplary process for facilitating fulfillment of an incentive associated with applying a financial transaction upon an account in the account set in the environment of FIG. 1; and

FIG. 10 depicts a flowchart of an exemplary process for facilitating fulfillment of an incentive conditioned on validating a spend upon accounts in an account set in the environment of FIG. 1.

### DETAILED DESCRIPTION

Financial transactions are processed among a set of accounts (“account set”), according to predetermined rules set up, in part, by a stakeholder, such as an accountholder, an issuer, a transaction handler (e.g., Visa), or a merchant. Transaction data associated with the financial transactions upon the accounts in the account set are accessed or analyzed through the use of tools within a system.

In one implementation, the transactions upon the accounts in the account set are routed according to the predetermined rules. For example, an accountholder can link the account set to a single account identifier, such as an identifier of a credit card account or a virtual account. Advantageously, the accountholder is able to carry a single accountholder device such as a plastic credit card, debit card, cell phone, and the like to access multiple linked accounts to conduct a financial transaction with a merchant or other point of sale. Moreover, the loyalty features corresponding to the various linked accounts can be applied based on the routed transaction.

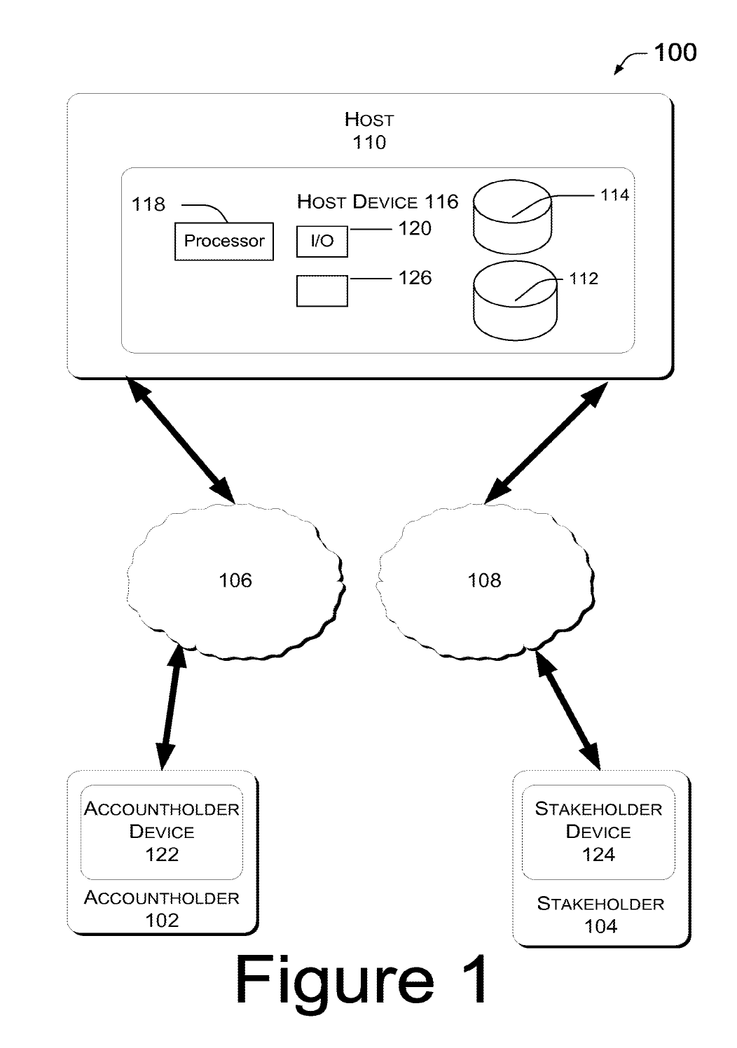

FIG. 1 illustrates an example by system 100 for processing of financial transactions upon accounts in an account set. To affect the processing of the financial transaction, the system 100 includes a host device 116 of a host 110 that is communicatively connected with a stakeholder device 124 of a stakeholder 104. The stakeholder 104 is an entity that is involved in the financial transaction with the accountholder 102. Examples of stakeholders 104 include: merchants (e.g., retailers or manufacturers), account issuers (e.g., banks, credit unions, savings and loan institutions, or brokerages, etc.), financial institutions, acquirers associated with corresponding merchants, or transaction handlers (e.g., Visa, MasterCard, or American Express). The host device 116 can be, but need not be communicatively connected to an accountholder device 122 of an accountholder 102. Here, the accountholder 102 is, for example, an accountholder of the account issued by an issuer, such as a joint account holder, or someone with access to the account for financial transactions, such as an employee with access to a corporate account. The host 110 can be in communication with the accountholder device 122 through a network 106 (e.g., a user network, which can be a public network 108 such as the Internet) and to the stakeholder devices 124 through a network 108 (e.g., a private network or a public network).

The host device 116, the accountholder device 122, or the stakeholder device 124, may each be a computing device (e.g., a special purpose computer) such as a server, a mainframe computer, a mobile telephone, a personal digital assistant, a personal computer, a laptop, an email enabled device, or a web enabled device having one or more processors (e.g., a Central Processing Unit, a Graphical Processing Unit, or a microprocessor) that executes an algorithm (e.g., software) to transfer funds by receiving data, transmitting data, storing data, or performing methods. Each host device 116, the accountholder device 122, or the stakeholder device 124 can include input/output capabilities (e.g., a keyboard, a mouse, a stylus and touch screen, or a printer), and one or more data repositories (e.g., one or more hard disk drives, tape cartridge libraries, optical disks, or any suitable volatile or nonvolatile storage medium, storing any combination of databases, or the components thereof, in a single location or in multiple locations, or as an array such as a Direct Access Storage Device (DASD), redundant array of independent disks (RAID), virtualization device, . . . etc., structured by a database model, such as a relational model or a hierarchical model). The host device 116, the accountholder device 122, or the stakeholder device 124 can include wired and wireless communication devices which can employ various communication protocols including near field (e.g., “Blue Tooth”) and far field communication capabilities (e.g., satellite communication or communication to cell sites of a cellular network), and which may support a number of services such as: Short Message Service (SMS) for text messaging, Multimedia Messaging Service (MMS) for transfer of photographs and videos, or electronic mail (email) access.

By way of example, the host device 116 is shown as a server, including a processor 118 and a server readable medium 126 storing executable computer code, an input/output means 120 (e.g., a display or a keyboard), and data repositories DB 114 and DB 112. The processor 118 accesses the executable code stored on the server readable medium 126, and executes one or more algorithms to transform data from one state to another, such as by applying rules stored in the tailoring DB 112 to transaction data about corresponding transactions (e.g., payment amount, date of transaction, merchant identifier of a merchant engaged in the transactions) stored in the transaction DB 114 or facilitating the use of tools that analyze the transaction data.

In some applications, the host device 116, the accountholder device 122, or the stakeholder device can include a cash register, a point of sale device, or a point of interaction (POI) device. A POI can be a physical or virtual communication vehicle that provides the opportunity, through a channel, to engage with the accountholder 102, the stakeholder 104, or the host 110 for the purpose of providing content, messaging or other communication, related directly or indirectly to the facilitation or execution of the transaction between the merchant 206 and the accountholder 102. Examples of the POI include: a physical or virtual Point of Service terminal (POS), a portable consumer device (e.g., mobile telephone) of the accountholder 102, a portable digital assistant, a cellular telephone, Internet web page rendered via a browser, or combination thereof. The stakeholder device 124, in particular, can include devices for reading magnetic strips and RFID devices. The accountholder device 122 can include a device with a volatile or non-volatile memory to store information such as the account number, a provider name, account or other identifier. Examples of accountholder devices 122 include: payment card, a gift card, a smartcard, a smart media, a payroll card, a healthcare card, a wrist band, a machine readable medium containing account information, a keychain device, such as a SPEEDPASS® device commercially available from ExxonMobil Corporation, or a supermarket discount card, and can include.

In some implementations, the accountholder 102 may have more than one accountholder device 122. For example, the accountholder 102 may have a first accountholder device 122 that is a computer with Internet browser capabilities and the second accountholder device 122 may be a plastic credit card that is used to interact with the stakeholder device 124, such as the POI terminal of the merchant 206.

The networks 106, 108, or other networks described in this application, may be public or private networks, and may include any of a variety of one or more suitable means for exchanging data, such as: the Internet, an intranet, an extranet, a storage area network (SAN), a wide area network (WAN), a local area network (LAN), a virtual private network, a satellite communications network, an Automatic Teller Machine (ATM) network, an interactive television network, or any combination of the foregoing. The networks may contain either or both wired or wireless connections for the transmission of signals including electrical connections, magnetic connections, or a combination thereof. Examples of these types of connections are known in the art and include: radio frequency connections, optical connections, telephone links, a Digital Subscriber Line, or a cable link. Moreover, networks may utilize any of a variety of communication protocols, such as Transmission Control Protocol/Internet Protocol (TCP/IP), for example.

Although a single host device 116, accountholder device 122, and stakeholder device 124 are shown here, it will be apparent that any number of entities and corresponding devices can be part of the system 100, and further that, while two networks 106 and 108 are shown, any number of networks could also be provided in the system 100. Additionally, although a specific set of components are shown here, it will be apparent to those of ordinary skill in the art that not all of the components shown here will be necessary in all processing of financial transactions, and further, that in some applications, a single network could also be used.

Referring again to FIG. 1, as appreciated by those skilled in the art, each of the tailoring DB 112 and the transaction DB 114, or components thereof, may consist of any combination of databases, or the components thereof, at a single location or multiple locations, or the tailoring DB 112 and the transaction DB 114 may be a single database. Moreover, the data stored in either or both of the tailoring DB 112 or the transaction DB 114 may be structured by a database model, such as a relational model or a hierarchical model, that may govern how data stored in the corresponding databases may be accessed. For example, query languages can be used to query the data stored in the tailoring DB 112 thereby distinguishing records that are relevant to the query. The databases may include any of a variety of security means such as: access codes, firewalls, compression, decompression, encryption, de-encryption, or the like.

The tailoring DB 112 may include data and rules that govern, at least in part, the processing of financial transactions within the system 100. For example, the rule may include a workflow sequence based on preferences of the accountholder 102 for processing of the financial transactions, a profile of the accountholder 102 including account identifiers of the accounts in the account set, names of accountholders of corresponding accounts in the account set, or an indication on how much of a spend of one of the accountholders is upon the account(s) in the account set. To illustrate, the tailoring DB 112 may include data indicating that: Sam Smith is an accountholder of a first reloadable gift card account with the account identifier “4234567890123456” in the account set; Sam Smith is an accountholder of a checking account with the account identifier “678890101003” in the account set; and that 70% of a $6000 US monthly total spend of Sam Smith is conducted upon the gift card account and the checking account.

The transaction DB 114 may include transaction data for transactions between the accountholder 102 and a merchant or trend analysis of the transactions. For example, the transaction data may include a transaction history of the transactions made payable upon one of the accounts in the account set (e.g., $10 US for shoes on Nov. 5, 2008 and $50 for groceries on Dec. 1, 2008) or a trend analysis based on the transaction history (e.g., a first accountholder tends to purchase groceries on a corresponding account in the account set every Monday). The trend analysis may be a result of a trend analysis algorithm that may incorporate statistics, data mining, or other mathematical calculations. Examples of trend analyses include: Market Basket Analysis, a pattern recognition analysis, optimization analysis, statistical analysis, a data mining analysis, demographic analysis, classification analysis, or segmentation analysis. To illustrate, the results of the Market Basket Analysis may reveal that accountholders 102 that have purchased lawn care items in April for each of the last four years are highly likely to purchase lawn care items in April of this year. In another example, the trend analysis may show highly correlative events, such as “accountholders who purchased a pair of shoes also buy a pair of socks within 90 days from the date of purchase of the pair of shoes.” The trend analysis may be derived through quantitative or qualitative research, market segment analyses, statistical modeling, regression analysis, econometrics, or data mining analysis, for example.

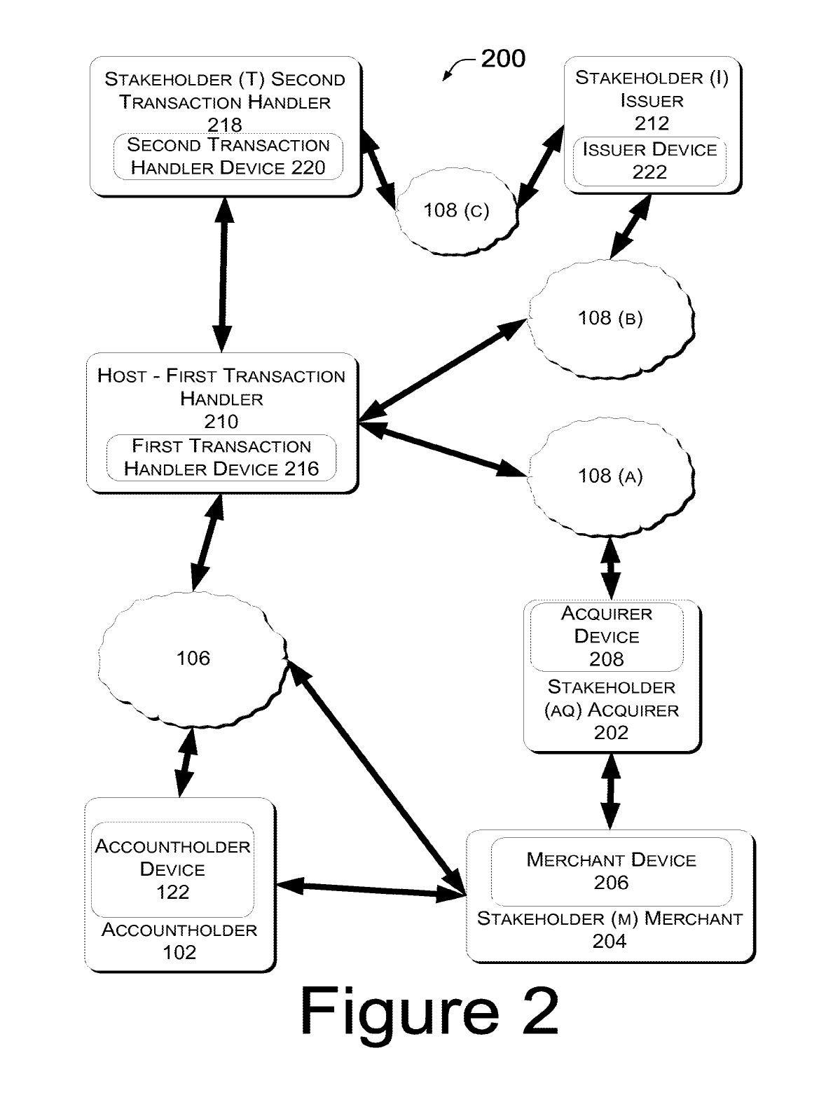

Referring now also to FIG. 2, the system 100 may operate in a payment processing system 200. As with system 100, the host 110, which is a first transaction handler 210 in FIG. 2, can be communicatively linked to the accountholder device 122 via the network 106. Here, the first transaction handler device 216 can be communicatively linked, via one or more private networks 108 (a-c) to a plurality of stakeholders 104, such as the stakeholder (m) merchant 204, stakeholder (aq) acquirer 202, stakeholder (l) issuer 212, or stakeholder (t) second transaction handler 218, each associated with a respective stakeholder device 124, merchant device 206, acquirer device 208, issuer device 222, and second transaction handler device 220, respectively. The merchant device 206 can also be communicatively linked to at least one accountholder device 122, either directly or through a public network 106 via, for example, a secure payment transaction webpage.

As previously discussed, during a typical financial transaction with the merchant 206, the accountholder 102 provides an account information (e.g., account identifier, an expiration date) associated with an account to the merchant 204 to initiate an exchange of currency for a resource (e.g., good or service). Thereafter, the merchant device 206 forms an authorization request that includes the account information received from the accountholder 102 and data about the transaction, such as information about the resource being purchased, the date of the transaction, or a merchant identifier such as a Merchant Category Code (MCC).

The types of goods or services being purchased are typically categorized based on Merchant Category Codes (MCC). The MCCs are numeric values that are instituted by the International Organization for Standardization (ISO) to define a particular merchant or category of merchants. A person of ordinary skill in the art will understand that most service orientated businesses, such as travel services, have a unique MCC. Conversely, sellers of goods generally have a common or shared MCC value based on the category or industry of the goods. For example, each national airline carrier or car rental company has its own unique MCC. However, companies that provide, for example, office supplies and printing products are all grouped under a single MCC.

Therefore, the authorization request may have several data fields each containing respective information that can be used to process or route the transaction within the payment processing system 200. For example, as is known by those of ordinary skill in the relevant art, the data fields may include: a name of the accountholder 102, the account identifier (e.g., Primary Account Number or “PAN”), an expiration date of the accountholder device 122, a Card Verification Value (CVV), a Personal Identification Number (PIN), a discretionary code of the issuer 212 of an account, a date, a time of the transaction, a merchant identifier (e.g., MCC) of the corresponding merchant 204, data usable to determine a location of the merchant, a Point of Interaction (POI) identifier, a total transaction amount, a Universal Product Code of the resource being purchased, a Stock Keeping Unit of the resource being purchased, a promotion code, an offer code, or an acquirer code of the financial institution associated with the corresponding merchant 206.

The merchant device 204 sends the authorization request to the acquirer device 208. The acquirer device 208 forwards the authorization request, and perhaps other information, to the first transaction handler device 216 via the network 108 (a). The first transaction handler device 216 may, in turn, forward the authorization request, and perhaps other information, to the issuer device 222 via the network 108 (b). In some implementations, the first transaction handler device 216 may forward the authorization request to the second transaction handler device 220 of the stakeholder (t) second transaction handler 218 who then forwards the authorization request to the issuer device 222 via the network 108 (c).

The issuer device 222 responds to the authorization request by sending an authorization response back to the first transaction handler device 216 via the network 108 (b). The authorization response may include an authorization of the payment transaction or a decline to authorize the payment transaction. The issuer device 222 may authorize the payment transaction after a determination that the account has sufficient funds to cover payment for the resources being purchased or that the transaction has a low risk of fraud, for example. The first transaction handler device 216 may, in turn, forward the authorization response to the acquirer device 208, via the network 108 (a), which forwards the authorization response to merchant device 206. Once approved, the merchant 204 may record the authorization, allowing the accountholder 102 to receive the resource from the merchant 204 or an agent thereof.

The authorization request and authorization responses are typically processed in real-time, as the transaction is occurring. Thereafter, the merchant 204 may, at discrete periods, such as the end of the day, submit a list of authorized transactions to the acquirer device 208 or other transaction related data for processing through the payment processing system 200, such as for clearing and settlement. Clearing includes the exchange of financial information between the issuer 212 and the acquirer 202 and settlement includes the exchange of funds. The first transaction handler device 216 may route the clearing and settlement request from the corresponding acquirer device 202 to the corresponding issuer device 222. Once the acquirer device 208 receives the funds from the accountholder 102 account upon which the transaction was conducted, the acquirer 202 can make the funds available to the merchant 206 less any transaction costs, such as fees.

The settlement of the transaction may include depositing an amount of the transaction settlement from a settlement house, such as a settlement bank, which the transaction handler 210 typically chooses, into a clearinghouse, such as a clearing bank, that acquirer 202 typically chooses. The issuer 212 deposits the same from a clearinghouse, such as a clearing bank, which the issuer 212 typically chooses, into the settlement house. If the transaction involves a debit or pre-paid account, the acquirer 202 may choose not to wait for the transfer of funds prior to paying the merchant 204. There may be intermittent steps in the foregoing process, some of which may occur simultaneously. The payment processing system 200 will preferably have network components suitable for scaling the number and data payload size of transactions that can be authorized, cleared and settled in both real time and batch processing. These include hardware, software, data elements, and storage network devices for the same.

As is known by those of ordinary skill in the art, transaction clearing can be provided using single-message processing or dual-message processing. A single-message system (SMS) provides a method for contemporaneously authorizing and clearing a transaction using a single message, which carries all information needed to post a transaction to an account and to enable clearing and settlement. Accordingly, for the single-message system (SMS), the authorization request and response messages include the necessary clearing and settlement information to further support and deliver online authorization, clearing, and settlement services for each individual transaction. For those financial transactions that use the single-message processing system, no additional clearing steps are required to clear the transaction. Rather, the authorization request and response messages include all the necessary information to clear the transaction.

However, where the dual-message processing system is being utilized, the financial clearing of the transaction is completed after the actual transaction has taken place, that is, after the transaction authorization process is completed. Thus, additional clearing steps are required for the dual-message processing once the transaction authorization process is completed. Thus, a typical payment transaction involves various entities to request, authorize, and fulfill processing the payment transaction.

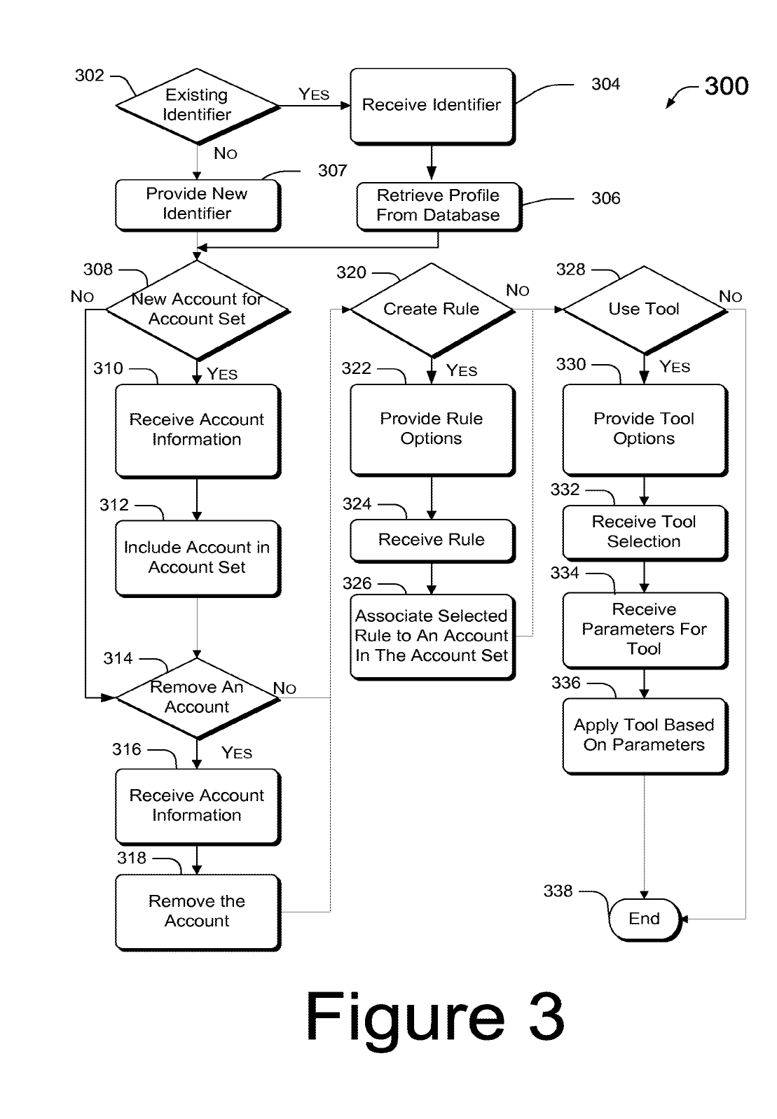

Referring to FIG. 3, a flowchart depicts an exemplary process 300 for tailoring transaction processing upon accounts by associating the accounts within an account set, creating rules governing the processing of the transactions, or using tools for analyzing transaction data within the system 100 or the payment processing system 200.

In one implementation, the accountholder 102 initially registers to link accounts in the account set such that the accounts in the account set are correlated to an account set identifier. The account set identifier is usable to distinguish the account set or the accounts in the account set within the system 100 or the payment processing system 200. For example, the account set identifier can be an account number of one of the accounts in the account set, an email address of an accountholder.

The registration process for the accountholder 102 can be facilitated at, for example, the website of the primary account issuer 212 or the website of the host 110. To illustrate, the accountholder device 122 accesses the transaction handler device 216, such as by using a browser to access an Internet Protocol address of the first transaction handler device 216 (e.g., a Uniform Resource Locator of a webpage of the first transaction handler 216 or a financial institution) via the network 106.

At a step 302, the accountholder device 122 receives a transmission inquiring whether the accountholder 102 has a user identifier associated with a previously created account set. If the accountholder 102 provides the user identifier, such as by entering an alphanumerical code in a data entry field of an interactive webpage, the process 300 moves to a step 304; alternatively, the process 300 moves to a step 307 wherein the accountholder 102 receives a new user identifier. At the step 304, the host device 116 receives the accountholder 102 provided user identifier.

At a step 306, the user identifier is used to retrieve a profile for the previously created account set from a database, such as the tailoring DB 112. The profile may include information about the accountholder 102, such as: a name of the accountholder 102; an address of the accountholder 102; a marital status; a demographic; account identifiers of accounts included in the account set and usable to distinguish or identify the respective account from other accounts within the payment processing system 200; an issuer identifier of the issuer 212 that issued at least one of the accounts in the previously created account set; accountholder identifiers that each identify a corresponding accountholder 102 of at least one account in the previously created account set, or a combination thereof, for example.

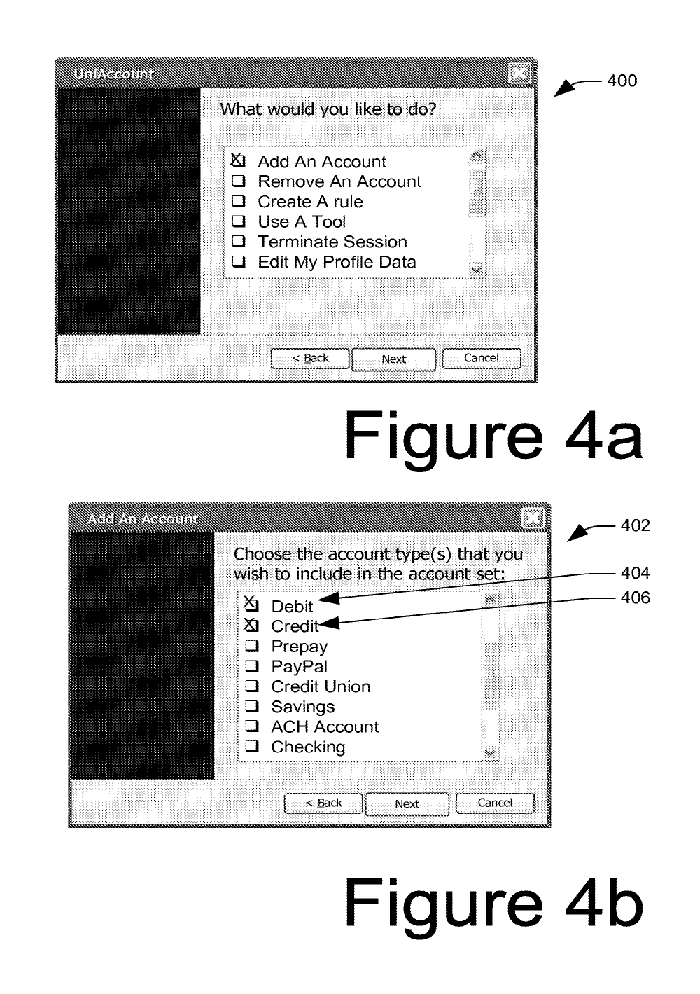

Referring to FIGS. 3 and 4, the process 300 moves from the step 306, or alternatively from the step 307, to a step 308. At the step 308, the accountholder 102 receives a transmission querying as to whether the accountholder 102 would like to associate (e.g., link) a first account to the account set. Linkages can be created by providing an account number, which can be the physical card account number or a virtual account number. As previously stated, a first credit card registered as a primary account can be linked to one or more secondary accounts, such as additional credit cards, debit cards, reloadable pre-paid cards, checking account, a flexible spending account (FSA) and/or a health savings account (HSA).

If the accountholder 102 selects to associate the first account, the process 300 moves to a step 310; alternatively, the process 300 moves to a step 314. By way of non-limiting example, one or more such transmissions may be rendered in a form of a webpage upon a display on a User Interface (UI) such as a UI 400 in FIG. 4a. The UI 400 may provide a single query or multiple queries. As illustrated in FIG. 4a, the queries of the steps: 308, 314, 320, or 328 may be rendered as a list of selectable options to the accountholder 102 at the UI 400. The accountholder 102 may select one or more of the selectable options. Moreover, although shown in a sequential flow in FIG. 3, the steps 308, 314, 320, or 328, may be executed concurrently or consecutively in any order.

At the step 308, the host 110 may receive a selection of a type of the account that the accountholder 102 wishes to include in the account set. For exemplary purposes and not by way of limitation, a UI 402 in the FIG. 4b may render a list comprising a plurality of selectable types of accounts. For example, the accountholder 102 may wish to include a debit and a credit account in the account set, such as an element 404 and an element 406, respectively, in the FIG. 4b. Alternatively, or in combination, the accountholder 102 may simply enter information about the account the accountholder 102 wishes to include in the account set, such as at a step 310.

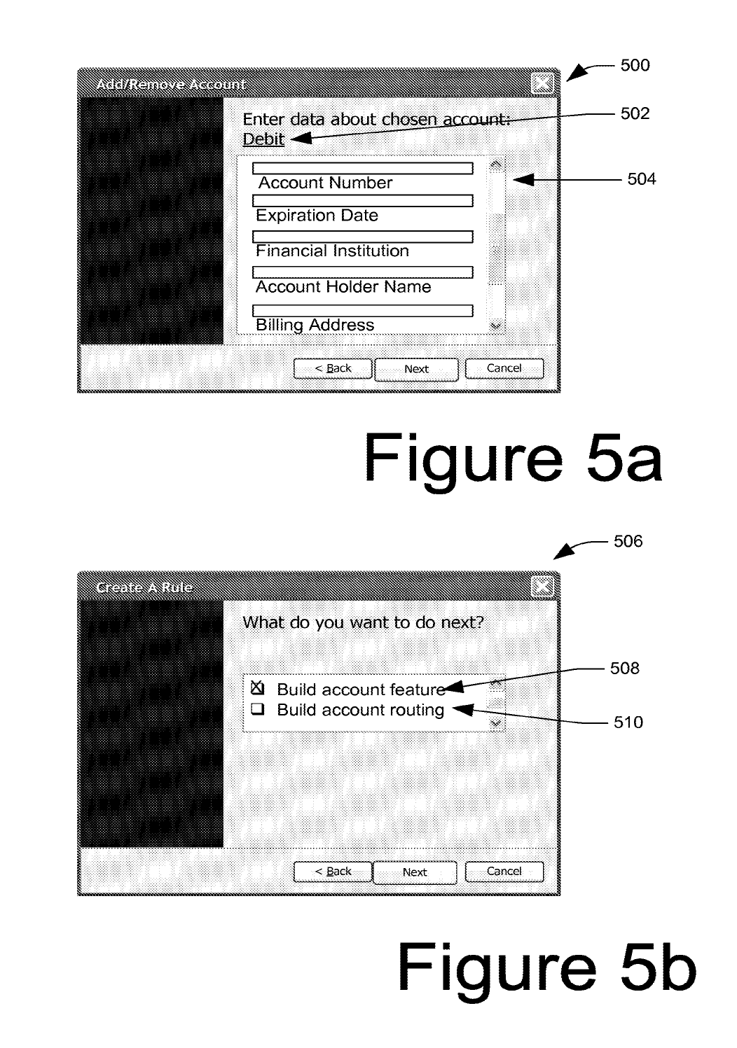

Referring to FIG. 5a and the step 310 in FIG. 3, the host 110 may receive account information for the account(s) the accountholder 102 wishes to include in the account set. For example, the accountholder 102 may utilize a UI 500 to enter data into account data fields, regarding the account(s) that the accountholder 102 wishes to include in the account set. As illustrated in FIG. 5a, the UI 500 may have pre-populated data field(s), such as the account type field 502, based on the data received via the UI 402, or the previously created account set, for example. The account data fields 504 may include such fields as: account identifier, account expiration date, an identifier for the financial institution issuing the account, a billing address, or other fields as would be known by those of ordinary skill in the art. At a step 312, the host 110 includes the account in the account set. For example, the account data received in the step 310 may be included in the tailoring DB 112 in association with the account set.

Alternatively, or in combination, at a step 314, the accountholder 102 may receive a transmission querying whether the accountholder 102 wishes to remove one of the accounts from the account set. If the accountholder 102 responds to the query by sending a transmission addressed to the host 110 indicating that the accountholder 102 wants to remove the account from the account set, the process 300 moves to a step 316; alternatively, the process 300 moves a step 320.

If the accountholder 102 wishes to remove one of the accounts from the account set, then, at the step 316, the accountholder 102 enters the account data about the account that the accountholder 102 wishes to remove from the account set, such as a corresponding account identifier. At a step 318, the account data is used to remove the account from the account set. Thereafter, the account is disassociated from the account set, such as by disassociating the account data from the account set in the tailoring DB 112.

After the account is removed, the accountholder 102 is given the option of including a rule, or using a tool (step 328) or of terminating the process 300 at a step 338. The steps 320-338 may be executed by the accountholder 102 or any of the stakeholders 104.

At the step 320 a determination is made as to whether the stakeholder 104 or the accountholder 102 would like to create a rule that will govern, at least in part, the processing of the transactions upon at least one of the accounts in the account set. For example, the accountholder 102 receives a transmission querying whether the accountholder 102 would like to create at least one rule. If it is determined that the accountholder 102 has selected to create the rule, the process 300 moves from the step 320 to a step 322; alternatively, the process 300 moves to a step 328. In other implementations, one or more of the stakeholders 104 can create the rule in a similar fashion.

In one implementation, the accountholder 102 may create at least one rule that will govern processing of transactions upon the account(s) in the account set. The accountholder 102 may enter the rule into the data fields of a respective UI. Alternatively, or in combination, at the step 322, rule options for the rules can be provided to the accountholder 102. Referring to the FIG. 5b, a UI 506 depicts exemplary rule option that can be displayed to the accountholder 102. Here, the accountholder 102 may select from two different types of rules: (1) to associate account features to at least one of the accounts in the account set (an element 508) and/or (2) to delineate routing of the transactions (an element 510) upon at least one of the accounts in the account set. Other rule options not depicted in the UI 506 are also applicable.

In one implementation, account features are associated to at least one of the accounts in the account set. The stakeholder 104 may provide the host 110 with a rule condition that, when satisfied, triggers the application of a specified account feature to the transaction. The specified account feature may be an account feature associated with a first account in the account set that is then applied to the transaction upon a second account in the account set. To illustrate, the stakeholder 104 may specify the condition as: “if a transaction is upon a debit account in the account set, then apply a loyalty feature of a specified credit account in the account set to the transaction upon the debit account in the account set.” For example, the currency amount of the transaction upon the debit account may result in corresponding loyalty points toward the loyalty program of the credit account in the account set. The stakeholder 104 may create other rules combining various permutations of accounts and account features.

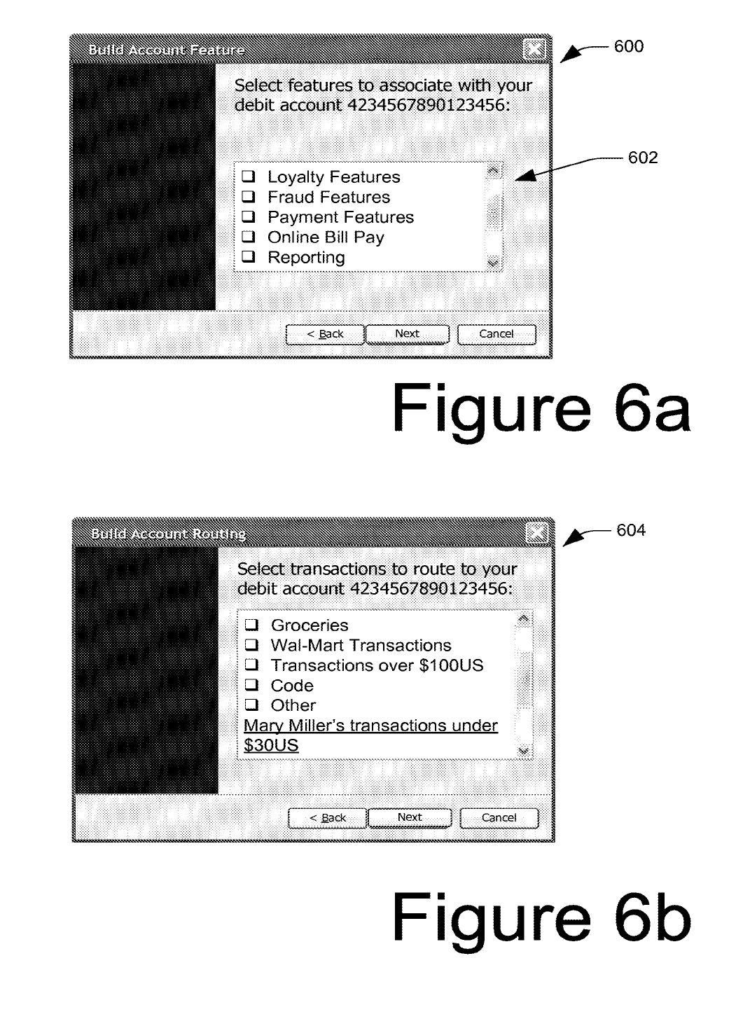

By way of example and referring to FIG. 6a, a UI 600 may render a list of account features that the accountholder 102 or stakeholder 104 may select from. For example, the accountholder 102 may first select categories of the account features that are available to associate with the debit account in the account set. An element 602 displays a portion of a list of the categories including: loyalty features; fraud features; online bill pay features; reporting features; or combinations thereof. Other categories are also applicable as denoted by the slide bar in the UI 600. The selection of the category of account features may then lead to other selections options. For example, if the accountholder 102 selects the category of the loyalty features, the accountholder 102 may be given a second list of account feature options such as: a point to reward ratio, receipt of a reward via a statement credit, or currency back options. Similarly, the fraud features may include account feature options such as: alerts, currency limits for authentication of corresponding transactions, online shopping security features, Personal Identification Number (PIN) entry requirement at specified geographic locations, or other such fraud features. The online bill pay features may include account feature options such as: access to payee and payor information, the ability to set up automatic bill pay to select billers, or bill pay reporting features such as receiving a report for the total amount paid to a specified biller over a duration of time. The reporting feature category may include account feature options such as: setting timing and criteria for the transmission of alerts, setting up automated reports about the transactions upon the account(s) in the account set that are intermittently sent (e.g., to the accountholder 102 or specified recipient), or delineating accountholder access rights to various reports on the metrics of account activity for one or more of the account in the account set.

The accountholder 102 or the stakeholder 104 may select from account features that are already associated with at least one account in the account set. For example, a list may be compiled of the account features that were associated with the respective accounts when they were first issued. The accountholder 102 may then select account features from the compiled list and assign the selected account features from the compiled list to various accounts in the account set. Alternatively, or in combination, the list may include account features that at least one of the financial institutions associated with corresponding account(s) in the account set are willing to offer as applicable toward at least one of the accounts in the account set, even if none of the accounts in the account set are currently associated with the offered account features.

In one implementation, the accountholder 102 may select from a group of base account features that can be applied towards any of the accounts in the account set and extra account features that the accountholder 102 may pay for with an extra fee. For example, the accountholder 102 may pay a monthly subscription fee of $4.00 US for a loyalty program feature offering the accountholder 102 1000 loyalty points for every $1.00 US spent on any of the accounts in the account set, even if the accountholder 102 is not an accountholder of all of the respective accounts in the account set. In another example, the accountholder 102 may choose to pay an annual fee of $5.00 US in order to associate concierge services with two of the three accounts in the account set even if none of the three accounts were originally issued with the account feature of concierge services.

A default setting may automatically allocate account features to some, or all, of the accounts in the account set. For example, the default setting may associate the account features of the most prestigious account to each of the accounts in the account set. To illustrate, the account features of a platinum card credit account may be automatically associated with an account set comprising (listed in descending hierarchical order of prestige): the platinum card credit account, a gold card debit account, and a prepay account.

A first account feature associated with a first account may be applied differently to the first account in comparison to the first account feature being applied to a second, associated account in the account set. For example, a ratio of dollars to loyalty points may be different for a debit account in the account set as compared to a credit account in the account set. To illustrate, the accountholder 102 that engages in a transaction for $100 US upon a corresponding debit account in the account set may earn 50 loyalty points while the accountholder 102 may have earned 100 points if the accountholder 102 had used a corresponding credit account in the account set to make the same purchase for $100 US.

Alternatively, or in combination, the accountholder 102 may create a rule delineating routing (“routing rule”) preferences for processing (or not processing) the transactions upon the account(s) in the account set (e.g., element 510 in FIG. 5b).

The routing rule may specify a routing condition usable to distinguish the transactions in the payment processing system 200 (e.g., “transactions with a Wal-Mart® store”) that are to be processed upon specified accounts in the account set. For example, the routing condition may specify a criterion for routing, such as: the resources purchased (e.g., “clothing,” “soccer gear,” items with a Universal Product Code in the range of 123456123456 to 123456900000); a threshold purchase amount of the transaction; a code that is to be entered at the POS of the merchant 206; the merchant identifier of the merchant 206; an accountholder identifier; or combinations thereof.

Similarly, the routing condition may be usable to distinguish the transactions in the system 100 that are not to be processed upon at least one of the accounts in the account set. For example, the accountholder 102 may create a routing rule for declining particular transactions. By way of example, the routing rule may request that the issuer 222 of the debit account in the account set with the account identifier “4234567890123456” decline authorization requests upon the debit account if the routing condition is satisfied (e.g., “decline the transaction on the debit account if the transaction originates from a country outside of the United States of America”). In another example, the accountholder 102 may request the first transaction handler 210 to decline the authorization requests on a credit account in the account set if the routing condition is satisfied (e.g., “decline the transaction on the credit account if the transaction does not qualify for an account feature protecting against fraud”).

In one implementation, the routing rules can determine automatically when each account in the account set should be used during a transaction such as a financial transaction for goods and/or services or an ATM withdrawal. For example, the accountholder 102 can establish rules to access and use a first account in the account set for all purchases made at drugstores and/or supermarkets, while using the second account in the account set for purchases with all other merchants. In another implementation, the routing rules can be part of an algorithm that includes an automated and a manual selection of the account. For example, a routing rule may direct the host device 116 to automatically prompt the accountholder 102 at a POS terminal to manually select from a list of available accounts at the time of a purchase. Here, after the accountholder device 122 has been “read” (e.g., via swipe or contactless chip) by the merchant device 206, the merchant device 206 can prompt the accountholder 102 with a selection menu, thereby allowing the accountholder 102 to select the appropriate account at the time of purchase. Similarly, an automatic teller machine (ATM) device or other stakeholder device 104 can be used to enable account selections via a pre-established numerical representation or account naming convention.

By way of example and referring to FIG. 6b, a UI 604 may display routing options available to the accountholder 102 or stakeholder 104. Here, the accountholder 102 or the stakeholder 104 is given an option to select the transactions that will be routed to the debit account in the account set, such as transactions: for groceries; with Wal-Mart Stores, Inc, (“Wal-Mart”); that are over $100 US; including a specific code; or other delineation, such as “Accountholder Mary Miller's, transactions under $30 US.” Other routing options are also applicable. To illustrate, the accountholder 102 may choose to have all transactions upon any of the accounts in the account set be routed to a Wells Fargo® checking account in the account set if the accountholder 102 enters a code (e.g., “SBrocks1”) at the POS of the merchant 206 engaged in the corresponding transaction.

The host 110 may apply the routing rules by forwarding the transactions satisfying the routing condition to the respective financial institution specified in the routing rule such as the issuer 212 of the destination account. To illustrate, the accountholder 102 may create the routing rule that an authorization request sent by a Wal-Mart® store upon any of the accounts in the account set should be routed to a credit account in the account set that has been issued by Bank of America, regardless of the account identifier included in the authorization request. Consequently, if the host device 116, such as the transaction handler device 216, receives an authorization request addressed from the Wal-Mart® store for $10 US upon a debit account in the account set that was issued by a Wells Fargo® bank, the first transaction handler device 216 will apply the routing rules and forward the transaction authorization request to the Bank of America® issuer 212 of the credit account to process the $10 US as payable upon the credit account. The Bank of America® issuer 212 may then determine whether to authorize the transaction for $10 US on the credit account.

In yet another example, the accountholder 102 may be the merchant 206 creating the routing rule such that funds from the transactions of the merchant 206 with the consumers are routed to specified accounts. For example, the merchant 206 may select to have funds transferred to a specified checking account when the transaction data for the transaction includes: a specified resource code (e.g., “clothing,” “soccer gear,” items with a Universal Product Code in the range of 123456123456 to 123456900000); a threshold purchase amount for the transaction (e.g. $5000 US); a specified merchant identifier (e.g., an affiliate merchant 206 or a franchisee of the merchant 206); an accountholder identifier; or combinations thereof, for example. To illustrate, the merchant 206 that is Walgreen Corporation, may want to have funds for transactions that occur at the Walgreens® pharmacy to go to a first merchant account in the account set of the merchant 206 while having other transactions at the Walgreens® stores to go to a second merchant account in the account set of the merchant 206. Here, when applying the merchant 206 routing rule, the host 110, such as the transaction handler, may route the funds for pharmacy transactions to the acquirer of the second merchant account.

In one implementation, the routing options may be based on the transaction history of the accounts in the account set. For example, if the transaction history of the accounts in the account set show that an accountholder, Sam Smith, tends to use the accounts in the account set for groceries and transactions with Wal-Mart, then the routing options for the debit account may include “groceries” and “Wal-Mart Transaction” in the list displayed in the UI 604.

The rule options provided in the step 322 include the options that bring the most value. For example, the host device 116 can calculate a value for the benefit(s) for each of a plurality of permutations of associated account features, routing rules, other created rules, or combinations thereof. In one implementation, the rule options provided in the step 322 are those permutations that result in higher benefit value(s) than other permutations. To illustrate, the accountholder 102 may have selected a loyalty feature such that transactions on a credit account have a $500 US to 1 loyalty point ratio for purchases at a Wal-Mart® store on the credit account in the account set and a $1000 US to 1 loyalty point ratio for purchases at the Wal-Mart® store on the debit account in the account set. Here, the “Wal-Mart Transactions” routing options may be included in routing options for the credit account in the account set but not be include the routing options for the debit account in the account set. Alternatively, the “Wal-Mart Transactions” may appear last in a ranked order list of the routing options for the debit account.

Alternatively, or in combination, the list of the options may be based on an interactive session with the accountholder 102 or the stakeholder 104. For example, the accountholder 102 may try different permutations of selected account features and routing rules while receiving reports provided by the host device 116 for the respective permutations. To illustrate, the accountholder 102 may select account features for two accounts in the account set. Thereafter, the accountholder 102 may receive a ranking of routing options based on the a predicted usage of the account features. The accountholder 102 may then change the selected account features to receive another ranking of routing options. Similarly, the accountholder 102 may select the routing rules first and then the accounts features, or select them concurrently.

Here, the host device 116 can access the transaction history of the accounts in the account set in order to predict the value of the benefit for a particular permutation. For example, the host device 116 can be utilized to determine a permutation of account features and routing rules for a debit and a credit account in the account set. The credit account in the account set may have 1:1 dollar to loyalty point ratio, but be limited to up to 100 loyalty points for gasoline transactions upon the credit account. On the other hand, the debit account may have a 4:1 dollar to loyalty point ratio but have no loyalty point accumulation limit. The host device 116 can access the transaction history of the accounts in the account set to determine an optimum permutation of account features and routing rules for the two accounts (the credit and debit accounts). To illustrate, data from the transaction DB 114 may show that last year $1000 US of gasoline was purchased using the two accounts in the account set. Assuming an average of $4.00/gallon price for gasoline based on known market values, the host device 116 can calculate the volume of gallons of gasoline purchased last year. Here, the $1000 US spent on gasoline results in about 250 gallons of gasoline purchased last year. The host device 116 can determine a predicted market value for gasoline for the upcoming year, such as by receiving the metrics from a third party indicating an average of $2.00 US per gallon for the upcoming year. Therefore, given last year's purchase amount of $1000 US, the host device 116 can predict that the two accounts will likely be used to purchase $500 US of gasoline this year (250 gallons×$2.00 US/gallon). The host device 116 can also be used to determine that the routing options should propose that gasoline purchases be routed to the debit account because it would result in a higher amount of accumulated loyalty points (debit: $500 US*1 loyalty point/$4 US=125 loyalty points; credit $500 US*1 loyalty point/$1 US=500=>100 loyalty points due to loyalty point limitations).

The routing options of the step 322 may include time delays, wherein rules can be set to change at a different time. In the gasoline example above, the routing options displayed to the accountholder 102 may indicate that gasoline transactions should be routed to the credit account until $100 US of gasoline has been purchased; thereafter, the transactions should be routed to the debit account. The accountholder 102 may then create the routing rule that includes a switch in transaction routing to the debit account at a later period based on a criteria of reaching $100 US worth of gasoline purchases on the credit account. Alternatively or in combination, the accountholder 102 may docket an alert to occur when the credit account has been charged up to $100 US for gasoline purchases.

At a step 324 of the FIG. 3, the rule is received. For example, the host 110 may receive a transmission addressed from the accountholder 102 wherein the accountholder 102 indicates that the accountholder 102 wishes to associate a specified account feature to one of the accounts in the account set or that the accountholder 102 wishes to route the transaction that was to occur on a first account to be routed to a second account in the account set. At a step 326, the rule is associated with the selected account in the account set. For example, the rule is stored in the tailoring DB 112 in association with the account identifier of at least one account in the account set.

The host 110 may decline the request of the accountholder 102 to associate the rule. For example, the accountholder 102 may request that when the issuer 212 is determining whether to authorize a transaction upon a respective credit card in the account set, the issuer 212 bases the authorization on a total credit limit available to the accountholder 102 across all accounts in the account set. The issuer 212, however, may not want to bear the risk of the entire credit limit. Consequently, the host 110 may accept or decline association or implementation of the rule created in the step 320. The acceptance or the decline may be based on, for example, predetermined operational limits—such a contractual agreement between issuers 212, acquirers 202, and the transaction handler 210 or 218.

The rules created in the step 320 may also be deactivated. The accountholder 102 may receive a transmission querying whether the accountholder 102 wishes to deactivate at least one rule. For example, the accountholder 102 may receive a transmission indicating deactivation options. To illustrate, a UI may render a list of all current rules stored in the tailoring DB 112 in association with the account set. Subsequently, the host 110 may receive a selection of the accountholder 102 indicating the current rules that are to be deactivated such that they no longer apply toward the processing of the transactions upon the accounts in the account set. The host 110 may deactivate the selected rule, for example, by disassociating the selected rule from the account set in the tailoring DB 112.

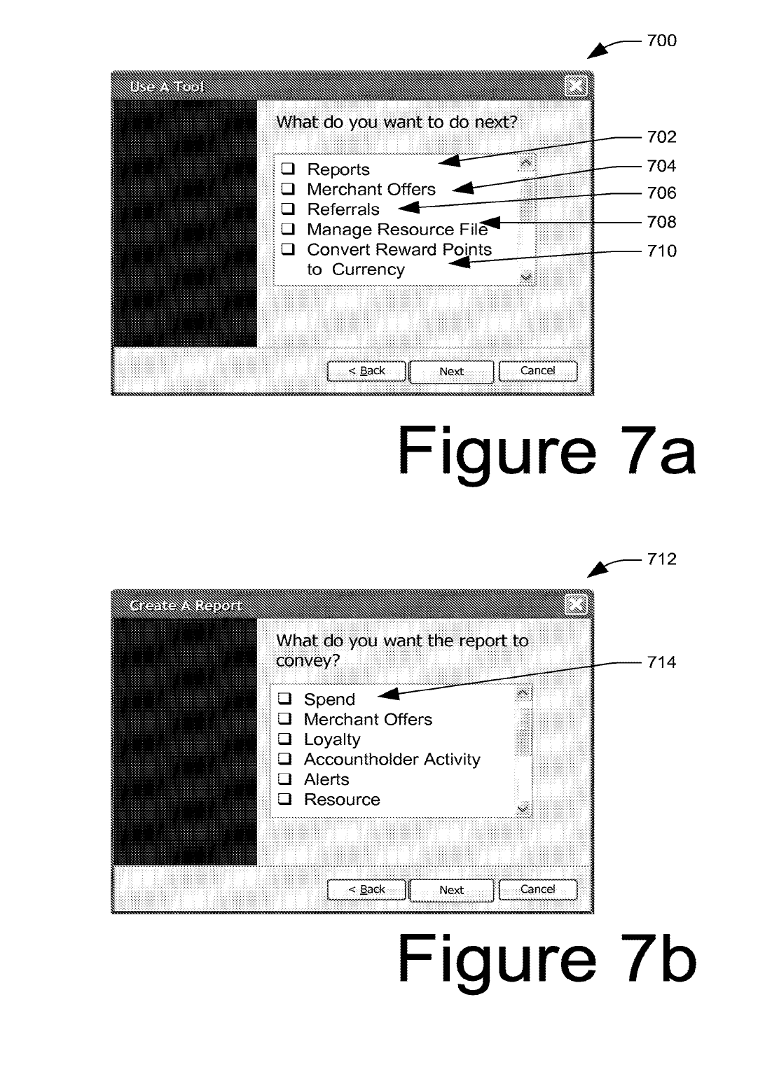

After the rule is associated with the account set in the step 326, the process moves to the step 328. At the step 328, the accountholder 102 or stakeholder 104 receives a transmission querying as to whether the accountholder 102 would like to use a tool. If the accountholder 102 or the stakeholder 104 wishes to use a tool, the process 300 moves to a step 330 wherein the accountholder 102 or stakeholder 104 is given an opportunity to select a tool; alternatively, the process 300 ends at step 338. The tools may be an executable code that can utilize data, such as the data in the tailoring DB 112 or the data in the transaction DB 114, to produce a result and/or to transform the data. Examples of the tools include: create a report, set up an alert function, or convert loyalty rewards to currency. Other tools, as would be known to a person of ordinary skill in the art, are also applicable. By way of non-limiting example, a UI 700, as depicted in FIG. 7a, may render a list of a plurality of tool options including: reports (a tool 702), merchant offers (a tool 704), referrals (a tool 706), manage resource files (a tool 608), convert reward points to currency (a tool 710), or other options, as conveyed by a slide bar in the UI 700.

At a step 332, the tool selection of the accountholder 102 or the stakeholder 104 is received. The accountholder 102 may enter a selection of the tools from the tool options of the step 330. For example, when selected, each of the tools 702, 704, 706, 708, or 710, may link to respective data entry forms, wherein the accountholder 102 or the stakeholder 104 may select parameters for the selected tool in a step 334. To illustrate, the accountholder 102 may select the tool 610 to convert reward points to currency. The tool 710 may lead to a data entry form wherein the accountholder 102 may determine how many points are available to convert to currency and enter the parameters for the currency conversion such as: a form of the currency (e.g., dollars, pounds, yen); a currency recipient such as the accountholder 102, one of the accountholders, or a consumer that is not an accountholder of one of the accounts in the account set (e.g., gift recipient); and means for delivering of the currency (e.g., statement credit, gift card, check). Here, the accountholder 102 may request that 100 loyalty points be converted to $100 US based on a point-to-currency ratio of a loyalty feature associated with one of the accounts in the account set and that the $100 should appear as a statement credit on a Bank of America® debit account in the account set. At a step 336, the received parameters from the step 334 are used to apply the tool. In the example above, the 100 loyalty points are converted to $100 US and issued as a statement on the Bank of America® credit account. The accountholder 102 may receive a confirmation notification after the loyalty points are converted such as an email transmission including a confirmation of the conversion.

Another exemplary tool may be a tool to facilitate the creation of a report (the tool 602). At the step 334, the accountholder 102 may provide parameters for the report such as specifying that the report include an analysis of the transaction history: of a specific account in the account set; spanning a duration of time; of specific merchant(s) 104 (e.g., “Wal-Mart”); of specified accountholder that can be identified by a corresponding accountholder identifier (e.g., “Mary Miller”); or a combination thereof. Referring to FIG. 6b, a UI 612 may render a list of report options to the accountholder 102 including a report on: spend, merchant offers (e.g., coupons, discounts, or targeted merchant offers), loyalty, account activity, alerts, or resources (e.g., purchased resources). For example, the accountholder 102 may indicate that the report should be rendered including information about the transaction history of the debit and the credit account in the account set, points accumulated due to transactions made payable upon the debit account for a specified period of time, points accumulated due to transactions made payable upon the credit account for the period of time, accountholder usage frequencies of the accounts in the account set, percentage spend upon one of the accounts in relation to a spend over all of the accounts in the account set, or a combination thereof. Other parameters for the report are equally possible, as would be known to those of ordinary skill in the art. The report may be rendered such as by being electronically displayed on a cellular telephone or computer of the accountholder 102 or designated recipient of the report (e.g., an accountholder 102 or an issuer 212 of one of the accounts in the account set). Alternatively, the report may be delivered by other means to the accountholder 102 or designated recipient, such as by airmail or a voice transmission.

The report may be a part of a notice function. For example, the accountholder 102 may indicate that a transmission including an alert be sent to the accountholder 102 if the spend on a debit account over a period of time exceeds the spend on the credit account over the period of time by a pre-determined threshold currency amount. In another example, the notice function may include the activity of a specified accountholder 102. To illustrate, assume both Sam and Mary are accountholders of at least one account in the account set. Sam may select the alert tool 702 to set up an alert so that Sam may receive a notice if the spend, over a specified period of time, of the transactions of Mary upon the accounts in the account set exceed a threshold currency amount.

### Exemplary Application of Rules

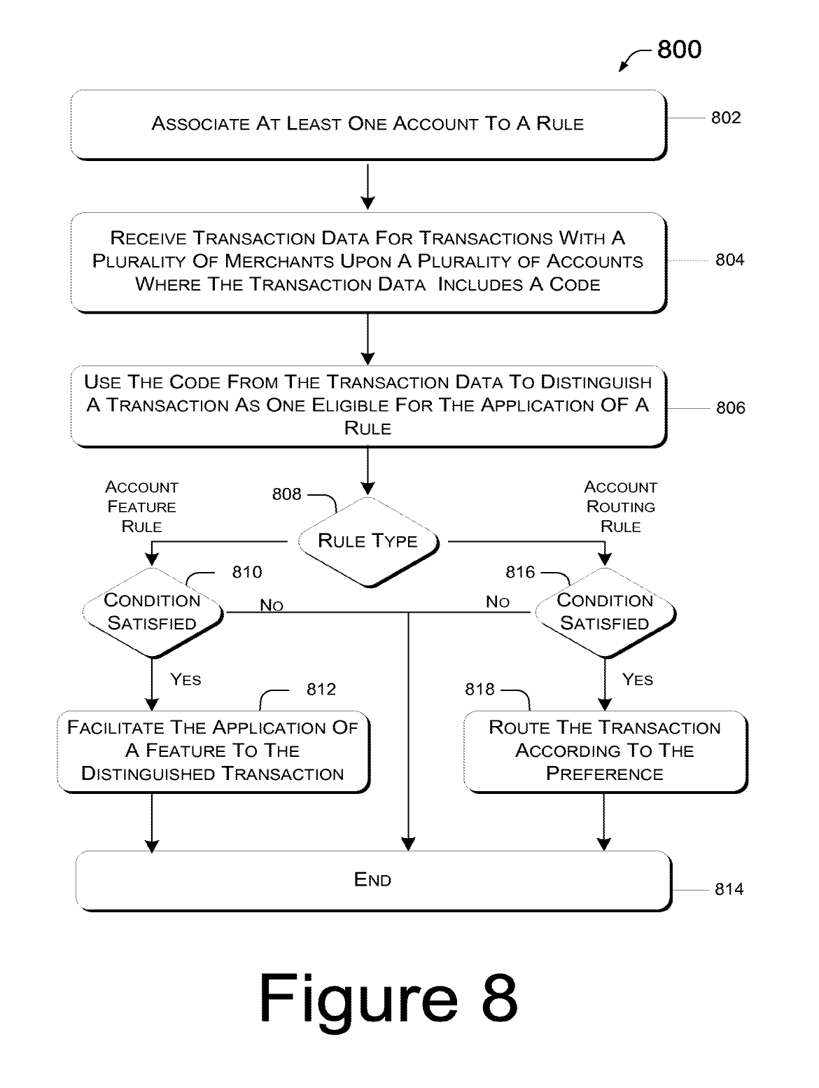

Referring to FIG. 8, a block diagram illustrates an exemplary process 800 for processing of the transactions upon the accounts in the account set in accordance, at least in part, with the rules received in the step 324 of FIG. 3. At a step 802 of FIG. 8, the rule received in the step 324 is associated to the account set or at least to one account in the account set (e.g., the step 326) that may be issued by different issuers 212 or associated with different payment processing systems (e.g., VisaNet or MasterCard). At a step 804, the transaction data for a plurality of transactions is received. Each received transaction may be between any of the accountholders 102 of a plurality of accountholders 102 and any of the merchants 206 among a plurality of the merchants 206.

Here, the transaction data may be received in real time or delayed, such as batched form. For example, the host 110 may receive multiple transmissions that are each received in real-time and each including the transaction data for a single transaction that is concurrently occurring with the receipt of the transmission. To illustrate, the transaction data may be received in an authorization request addressed to the issuer 212 for a transaction upon one of the accounts in the payment processing system 200. Alternatively, or in combination, the transaction data may be included in a transmission that is delayed, such as when a transaction that has already been authorized, cleared, or settled is transmitted to the host 110. Alternatively, or in combination, the transaction data may be included in a transmission including a batch of transactions, such as a clearing and settling request from an acquirer device 208 for the transactions of one of the merchants 206 over a period of time.

The transaction data for each corresponding transaction may include all code usable to distinguish the transactions upon one of the accounts in the account set. In one implementation, the code may be the account identifier of the account being used for the transaction. For example, the received transaction data for the transaction may include a checking account number that is usable to distinguish the corresponding checking account as one of the accounts in the account set. Similarly, the received transaction data may include the account number of a credit account in the account set or the account identifier of an Automated Clearing House direct debit account in the account set.

At a step 806, the received code included in the transaction data for each corresponding transaction is used to distinguish the transactions that are eligible for the application of the rule received in the step 324. For example, a comparison algorithm is executed that at least compares the received account identifier(s) in the transaction data with the account identifier(s) of the accounts in the account set stored in the tailoring DB 112. If a match exists, the transaction is eligible for the application of the rule received in the step 324. In one implementation, the host 110, such as the first transaction handler 210, receives an authorization request from the acquirer device 202 of the merchant 206 via the Network 108 (a). The first transaction handler device 216 then uses the processor 118 to execute the comparison algorithm to match the received account number in the authorization request with a corresponding account number of at least one account that is stored in the tailoring DB 112 in association with the account set. If a match exists, the transaction is eligible for the application of the rule.

At a step 808, the type of rule associated with the account set is determined. In one implementation, the code may be used to identify the type of rule(s) associated with the account set. For example, the account identifier received in the transaction data of the distinguished transaction of the step 806 is used to retrieve, from the tailoring DB 112, the rule associated with the respective account upon which the distinguish transaction is payable. If the type of the retrieved rule associated with the account in the account set involves the application of one of the account features, the process 800 moves from the step 808 to a step 810. Alternatively, or in combination, if the type of the retrieved rule associated with the account in the account set is one of the routing rules, then the process 800 moves from the step 808 to a step 816. In another implementation, both account feature and routing rules may be applied simultaneously.

At the step 810, a determination is made as to whether the condition of the retrieved account feature rule is satisfied. The determination may include steps such as: accessing the transaction DB 114 to retrieve the transaction history of the corresponding account identified in the distinguished transaction of the step 806, and determining if the retrieved transaction history and the transaction data received at the step 804 satisfy the condition of the rule, for example. To illustrate, the conditions of the account feature rule may be: that the distinguished transaction be upon a specified credit account in the account set, the transaction be towards the purchase of gasoline resource, and that the spend on the specified credit account not exceed $100 US for a specified duration. Here, at the step 810, the host 110 may: compare the account number in the transaction data in the distinguished transaction to the account number of the specified credit account in the tailoring DB 112 to find a match; compare an identifier of the resource in the transaction data of the distinguished transaction with an identifier of “gasoline,” such as by determining if the merchant 206 is a retailer of gasoline or if the Universal Product Code (UPC) of the purchased resource matches the UPC of “gasoline”; calculate the spend on the specified credit account by accessing the transaction DB 114 and summing the purchase amount for the transactions upon the specified credit account for gasoline over the specified duration; and compare the calculated spend with the threshold of $100 US. If all conditions are satisfied, the process 800 moves to a step 812; alternatively, the process 800 ends at a step 814.

At the step 812, the application of the account feature associated with the account set to the transaction data of the distinguished transaction is facilitated, based at least in part, on the rule received in the step 324. To illustrate, the received rule from the step 324 may be: “if an accountholder of the debit account in the account set conducts a transaction on the debit account, apply the purchase insurance feature of the credit account in the account set that is issued by the same issuer.” Thereafter, the host device 116 that is the first transaction handler device 216 may receive an authorization request for a transaction on the debit account in the step 804 towards a purchase of dishware. The transaction handler device 216 may determine that the transaction is being conducted by one of the accountholders 102 of the debit account in the account set by matching the account identifier in the authorization request to the corresponding account identifier of the accountholder 102 stored in the tailoring DB 112 (the step 806). After a determination is made that a match exists, the transaction handler device 216 may facilitate the application of the rule received in the step 824 by, for example, storing indicia in the tailoring DB 112 (or the transaction DB 114) about the insurance in association with the distinguished transaction. Alternatively, or in combination, the transaction handler device 216 may populate the authorization request with an indication that the purchase insurance of the credit account should be applied to the transaction, and forward the authorization request to the corresponding issuer device 222 of both the debit account and the credit accounts. The corresponding issuer may then apply the purchase insurance to the transaction upon the debit account by, for example, storing the transaction data (e.g., purchase price, name of the merchant 206 engaged in the transaction, a date of the transaction) in an issuer database in association with indicia about the purchase insurance.

The accountholder 102 may request to receive the benefit of the account feature. In the dishware example above, if the dishware is delivered broken to the accountholder 102 of the debit account, the accountholder 102 may submit a refund request to the issuer device 222 in the amount of the purchase price of the dishware. The issuer may retrieve the transaction data about the transaction, such as by accessing the issuer database to retrieve the transaction data associated with transaction or by querying the host 110 to transmit the transaction data for the dishware purchase from the transaction DB 114. The issuer device 222 may confirm that the transaction for the dishware was made payable upon the debit account and that the transaction is covered by the insurance purchase feature of the credit account. Thereafter, the issuer device 22 may: inform the accountholder that the refund is being sent, issue a check to the accountholder for an amount of the purchase price of the dishware, send a prepaid card in the amount to the accountholder 102, or apply a credit in the amount to the debit account of the accountholder 102, for example. Other means for providing the benefit of the account feature to the accountholder are also applicable such as sending a voucher in the amount of purchase price of the dishware as an attachment in an email to an electronic address of the accountholder.

Alternatively, or in combination, the process 800 may move from the step 808 to the step 816 wherein a determination is made as to whether the routing condition of the routing rule associated with the account set is satisfied. The determination may include accessing the tailoring DB 112 or the transaction DB 114. In the gasoline example above, the transaction DB 114 is accessed to calculate the spend on the credit account for gasoline purchases over a specified duration. Here, if the spend for the specified duration exceeds $100 US, the routing condition of the debit account is satisfied and the transaction should be routed such that the transaction becomes payable upon the debit account.

If the condition of the step 816 is satisfied, the process 800 moves from the step 816 to a step 818; alternatively, the process 800 ends at the step 814. At the step 818, the distinguished transaction is routed according to the routing rule associated with the account in the account set. Therefore, in the gasoline example above, the authorization request for the gasoline transaction is forwarded to the authorization request to the issuer of the debit account. The issuer 212 of the debit account can then, in turn, determine whether to authorize the gasoline transaction upon the debit account.

By way of non-limiting example, other implementations of the above disclosed systems and processes are described below:

### Exemplary Application of Routing Rules in Real-Time

In one implementation rules are used to route the transaction in real time to a corresponding issuer 212 of an account that is selected from among the accounts. Moreover, a loyalty feature is calculated based on application of the transaction upon the selected account.

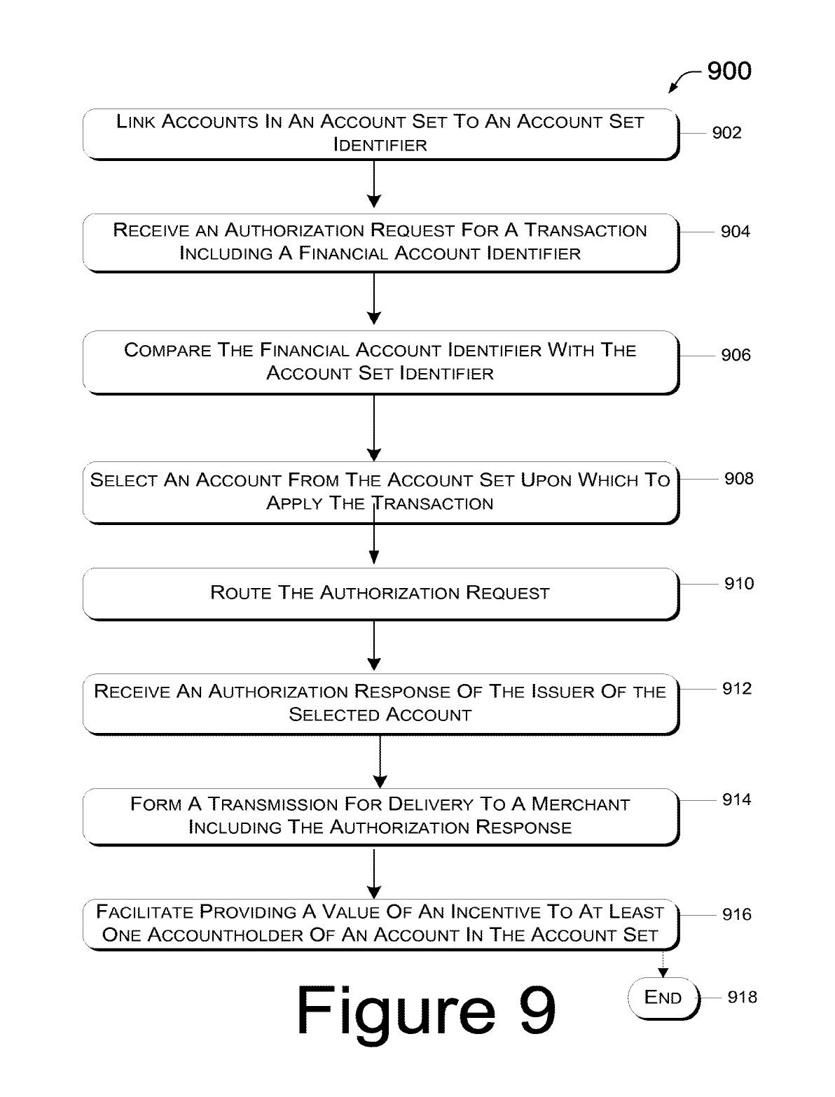

Referring to FIG. 9, a flow chart illustrates a process 900 for facilitating fulfillment of an incentive associated with applying a financial transaction upon an account in the account set. At a step 902, the host device 116 or, in this example, the transaction handler device 216, links a plurality of accounts within an account set such that they are each correlated (e.g., associated or linked) with an account set identifier. As stated previously, the accounts in the account set may be issued by different issuers 212, issued to different accountholders 102, associated with different transaction handlers 210 or 218, or a combination thereof. For example, the accounts in the account set may include: a Visa® debit account issued by Wells Fargo® bank to Sally Johnson and an American Express® charge account issued by American Express to Joe Smith.

In some implementations, the account set identifier is identical to a financial account identifier of one of the accounts in the account set. As stated previously the financial account identifier may be an identifier useable to distinguish the corresponding account within the system 100 or the payment processing system 200. Similarly, the account set identifier is usable to distinguish the account set or the accounts in the account set within the system 100 or the payment processing system 200. Here, a single identifier can distinguish both the financial account and the account set. To illustrate, both the account set identifier and the financial account identifier of an account in the set may be “4234567890123456.” Alternatively, the account set identifier and the financial account identifier may be different.

At a step 904, the transaction handler device 216 receives an authorization request from the acquire device 208 for a transaction between a consumer (e.g., one of the accountholders 102) and the merchant 206. The authorization request includes a financial account identifier. As is known by those of ordinary skill in the art, other information may also be included in the authorization request, such as an indicator of a good or product (e.g., UPC) of the merchant that is being purchased. Here, for example, Joe Smith may have swiped an American Express® charge card at a POI terminal of the merchant 204. The POI terminal then sent the authorization request to the acquirer device 208 including the account identifier of the American Express® charge card. The acquirer device 208, in turn, sent the authorization request to the transaction handler device 216.

At a step 906, the transaction handler device 216 compares the received financial account identifier with the account set identifier to find a match. For example, the transaction handler device 216 may use a look up table to compare the received financial account identifier of the American Express® charge card with a plurality of account set identifiers stored in the DB 112 or DB 114 that are each associated with a corresponding account set. After a match is found, the process 900 moves from the step 906 to the step 908.

At the step 908, the transaction handler device 216 selects at least one financial account, from among the account set, to apply the transaction. As stated previously, a business rule may include instructions usable to select the financial account as delineated by at least one stakeholder 104, such as the accountholder 102 or the issuer 212. To illustrate, the accountholder 102 may have delineated the business rule as “Route transactions for groceries upon any of the accounts in the account set to the Visa® debit account.”

In one implementation, the business rule includes selecting an account within the account set based on a value of an incentive. For example, the transaction handler device 216 may execute an optimization algorithm to select the financial account from among the account set by at least comparing the value of incentives of respective loyalty features associated with applying the transaction upon each of the financial accounts in the account set with a criterion. To illustrate, the transaction handler device 216 can calculate a value for an incentive associated with applying the transaction upon the Visa® debit account in the account set and a value for an incentive associated with applying the transaction upon the American Express® charge account in the account set. The transaction handler device 216 can then compare the calculated values with a criterion, such as “the most valuable incentive.” Here, the transaction handler device 216 may select the Visa® debit account for the transaction because the value of the resulting incentive is higher than that of the American Express® charge account incentive. Other forms of criteria are also applicable, such as the most points, the incentives that the accountholder 102 has indicated as most valuable, and the incentives that have the latest expiration date, for example.

At a step 910, the transaction handler device 216 routes the authorization request in order to receive a corresponding authorization response from the issuer 212 of the selected account. For example, the transaction handler device 216 can send the authorization request, via the network 108 (b), to the issuer of the Visa® debit account. Alternatively, or in combination, the transaction handler device 216 can send the authorization request to the second transaction handler device 220 that then sends the authorization request to the corresponding issuer, via the network 108 (c).

In one implementation, the authorization request is modified before routing the transaction to the issuer device 222 or second transaction handler device 220. For example, the first account identifier in the original authorization request may be replaced with an account number of the selected account. The authorization request with the replaced account number is, then routed to the issuer device 222 associated with the selected account (which may or may not be the issuer 212 associated with the first account identifier). The authorization request is processed as if the accountholder 102 used the selected account to conduct the financial transaction.

At a step 912, the transaction handler device 216 receives the corresponding authorization response of the issuer 212 of the selected account. At a step 914, the transaction handler device 216 forms a transmission including the authorization response for delivery to the merchant device 206 of the merchant 204 engaged in the transaction.

At a step 916, the transaction handler device 216 facilitates providing the value of the incentive, corresponding to applying the transaction upon the selected financial account, to at least one accountholder of an account in the account set. In the above grocery example, the application of the transaction to the Visa® debit account may have resulted in a $100 US in credit. Here, transaction handler device 216 facilitates providing the $100 US to at least one accountholder 102, such as the consumer that engaged in the transaction, Joe Smith. Alternatively, or in combination, the value may be provided to another accountholder 102 of an account in the account set, such as by facilitating crediting the Visa® debit account of Sally Johnson. For example, the transaction handler device 216 may send a transmission to the corresponding issuer device 222 including a notification about the incentive due.

In one implementation, some or all of the steps of process 900 may occur in real time. For example, the steps 902 through 914, and optionally the step 916, can occur while the consumer is interacting with the POI terminal of the merchant 204 during the transaction. Consequently, the steps 902 through 914 may occur within milliseconds to minutes, for example.

In another implementation, an indication of the value of the incentive is included in the transmission to the merchant device 206. To illustrate, the authorization response may be populated with data that describes the incentive. For example, the populated data may cause the POI to render a message to the consumer, such as “You just earned $100 US” or “We have debited the Visa account for the amount of the transaction but credited the American Express account by $100 US worth of incentives.”

### Routing Code Example

Execution of the process 900 can be illustrated in the following example. Sam Smith, the accountholder of the debit account in the account set, may create a business rule requesting that all Sam Smith transactions that include a specified code be routed to a credit account in the account set. The host 110 may associate the specified code with the account set or the credit account (the step 902). Thereafter, Sam Smith may bring a Radio Frequency IDentificaiton (RFID) debit card associated with the debit account in the account set into proximity of an RFID reader POS of the merchant 206 at the time of the transaction. Sam Smith may also enter the specified code into the POS. The merchant 206 may, in turn, transmit an authorization request to the acquirer of the merchant 206, wherein the authorization request includes the account number of the debit account and the entered specified code. The acquirer device 208 may forward the authorization request to the transaction handler device 216, which is the host device 116 (the step 904). The transaction handler device 216 may utilize the specified code to determine that the corresponding transaction is a transaction eligible for the application of at least one rule associated with the account set (the step 908). Moreover, the transaction handler device 216 may determine that the routing condition for the business rule for routing the transaction is satisfied by determining that the specified code was included in the eligible transaction (the step 908). The transaction handler device 216 may then route the authorization request to the issuer device 216 of the specified credit account (the step 910). Similarly, when the transaction handler device 216 receives the clearing and settling request from the merchant 206 for the eligible transaction, the transaction handler device 216 forwards the clearing and settling request to the credit account issuer rather than the debit account issuer 212.

### Dual Account Type Feature Sharing Example

The account features of a first account in a first account category can be applied to transactions made payable upon a second account in a second account category. The first account and the second account may be issued by different issuers or be associated with transaction handlers 210 or 220. In one implementation, the first account and the second account are each associated with a single transaction handler 210 and are each issued by a single issuer 212. The revenue received in association with processing of transactions on a debit account may not off-set the cost of providing certain account features, such as fees that an issuer 212 pays a transaction handler 216 for facilitating the application of the account feature to transactions. For example, most debit accounts are not associated with concierge features because it may not be cost efficient. In this implementation, when both a debit and a credit account are issued to a single accountholder 102, the revenue received in association with processing the transactions on both the debit and the credit accounts may be enough to off-set the cost of providing to the debit account, account features that are typically only offered in association with the credit account.

Here, accountholder 102, may include each of the credit account and the debit account in the account set (the step 308). The accountholder 102 may provide the respective account numbers of each of the credit account and the debit accounts to the host 110 (the step 310) and create the rule for tailoring processing of the transactions upon each of the credit account and the debit account (the step 320). For example, the accountholder 102 may indicate that the concierge feature of the credit account is to be applied toward the transactions made payable on either the credit account or the debit account. Thereafter, the accountholder 102 may call a concierge to inquire about top local restaurants while giving the concierge the account number of the debit account in the account set. The concierge may confirm that the debit account is associated with the concierge feature by, for example, inquiring from the host 110 if the corresponding debit account number is associated with the concierge feature. Thereafter, the concierge may provide a response to the inquiring accountholder 102.

The accountholder 102 may pay a fee for the account features associated with both accounts that is different from the fee the accountholder 102 would have paid for each account alone. For example, if the issuer 212 paid a $0.003 US per transaction fee to the transaction handler 210 for the account feature of concierge services to be associated with the credit account alone, the issuer 212 may pay $0.004 US per transaction fee to the transaction handler for the concierge services to be associated with both the debit and the credit accounts.

### Feature Sharing Example

The account feature of a first account that is associated with a second account in the account set may remain associated with the second account even after the first account is removed from the account set. For example, the accountholder 102 may include a debit account in the account set (the step 308). The consumer may maintain a positive balance on the debit account for a period of time such that the issuer or the transaction handler 210 assign a low risk score to transactions made payable upon the debit account. Thereafter, the accountholder 102 may add a newly activated credit account to the account set. The transaction handler 210 may associate the low risk score of the debit account to the newly activated credit account because the transaction history of the debit account implies that the accountholder 102 has reliable shopping habits. The low risk score may continue to be associated with the credit account even if the debit account is closed or removed from the account set.

In another example, the account set may include a checking account having an automatic bill pay feature, wherein the bank managing the checking account automatically submits checks to billers based on pre-selected bill pay rules linked to the checking account. The accountholder 102 may add a credit account, possibly issued by a different bank than the bank managing the checking account, to the account set (the step 308). The automatic bill pay feature may be associated with the credit account (the step 320). For example, a billing cycle, a payment amount, a payor identifier, and a payor address may be linked to the credit account such that the funds due to the payor may optionally be taken, at least in part, from the credit account. Thereafter, if the checking account is closed or removed from the account set, the automatic bill pay features may continue to be associated with the credit account. Similarly, the routing rules may include a business rule that delineates a succession of accounts for payment of a bill. For example, if a first identified account does not have a balance to pay the bill, then the bill is automatically paid through a second identified account in the set.

In yet another implementation, the host 110, such as the transaction handler 210, executes a computer code to calculate the risk score based on the transaction history of one or more accounts in the account set that may be issued by different issuers to a single consumer. The host 110 then communicates the risk score to a plurality of issuers that each bid to issue a new account to the consumer. The issuers 212 may base their respective bids on the communicated risk score such as by determining an Annual Percentage Rate (A.P.R.), a credit limit, a loyalty feature, or other qualities of an account on the communicated risk score. The bids are communicated to the host 110. The host 110, the accountholder 102, or a combination thereof, in turn, selects the bid that most closely matches set a criterion. For example, the accountholder 102 may select the bid that provides the best loyalty feature. Alternatively, or in combination, the host 110 may select the bid with the lowest A.P.R.

### Householding Multiple Accounts Across Multiple Transaction Handlers

Members of a household (e.g., husband, wife, or kids) may each have accounts that are issued by different issuers. For example, the husband and wife may each be accountholders of a Visa® debit account while the wife may be the accountholder 102 of an American Express® business account. The wife may provide the host 110 with the account information for both the Visa® debit and the American Express® business accounts (the step 310). The wife may also create a routing rule instructing that all transactions for groceries including the account identifier of the American Express® business account be routed to the Visa® debit account (the step 320). Consequently, the wife need not utilize a debit card associated with the Visa® debit account when making grocery purchases. Rather, the wife may swipe a card associated with the American Express® business account at the POI of the grocery store knowing that it will be routed to the Visa® debit account instead (the step 818).

### A Uniaccount Global Unique Identifier (GUID) Example

In one implementation, a uniaccount GUID (e.g., “4123456789123456”) associated with the account set can be utilized to process transactions upon at least one of the accounts in the account set. The transaction data for a corresponding transaction may include the Uniaccount GUID (e.g., an authorization request may include “4123456789123456”). The host 110 may use the uniaccount GUID to determine if the routing condition has been satisfied (the step 816) and to route the transaction according to the preference (the step 818).

To illustrate, the account set may include 5 accounts issued by different issuers, each with respective account identifiers. A uniaccount GUID having a “4” as the first “digit” can be assigned to the account set and stored in the tailoring DB 112 along with respective routing rules (e.g., all transactions for groceries having the uniaccount GUID be routed to the checking account in the account set). The accountholders 102 of the five accounts may receive respective uniaccount cards having the uniaccount GUID stored in the magnetic stripe of the card. Thereafter, one of the accountholders may make a purchase at a grocery store by swiping a corresponding uniaccount card at the POI of the merchant 206. The POI may submit an authorization request through the payment processing system 200 wherein the acquirer 202 of the merchant 206 forwards the authorization request to the host 110 that is a Visa® transaction handler (e.g., the “4” in the uniaccount GUID indicates that the transaction is to be forwarded to Visa Inc.). The Visa® transaction handler may then determine if the routing rule condition is satisfied (the step 816) and route the transaction according to the preference (the step 818). For example, here, the Visa® transaction handler may route the grocery transaction to the checking account in the account set by submitting a transmission including at least some of the transaction data to the bank managing the checking account.

In some implementations, the account identifier of the account on which the transaction will be made payable will be included in a transmission as the transaction is routed according to the preference. For example, the host 110 may be the transaction handler 210 that receives an authorization request for a transaction with a Safeway® store. The routing rules for the account set may indicate that the transactions having the uniaccount GUID should be routed to a specified credit account having a respective account identifier. The transaction handler 210 may include the account identifier of the specified credit account in the authorization request prior to sending the authorization request to the issuer 212 of the specified credit account. In another example, the uniaccount GUID in the authorization request may be replaced with the account identifier of the specified credit account. The issuer 212, in turn, may process the transaction as it would any other transaction upon the credit account.

### Multiple Acquirers and Transaction Handlers Transaction Routing Example

Here, a merchant 206 is the accountholder 102 of the system 100. The merchant 206 may have two merchant accounts. The merchant 206 may create the routing rule that routes funds for transactions conducted at a pharmacy of the merchant 206 to the first merchant account (the step 320). The host 110, such as the transaction handler or other financial institution, may then route the received funds according to the preferences of the merchant 206 (the step 818).

### Application of Exemplary Tools

The accountholder 102 may utilize the tool to access the data in either or both the tailoring DB 112 or transaction DB 114, analyze the corresponding data, transform the corresponding data, or a combination thereof, for example. The transaction history of the transactions upon the accounts in the account set may be analyzed or mined to determine purchasing behavior of corresponding accountholder(s) (or groups of accountholders of accounts in the account set) to: create or apply targeted merchant offers; assess risks; provide referrals; provide targeted purchased resource related services; provide reports; or combinations thereof.

### Incentive Conditioned on Validation of Spend Example

The transaction history of the transactions upon the account(s) in the account set may be used to create and apply offers that are targeted (“targeted offer”) to the accountholder(s), such as targeted offers that are based on the interests, shopping habits, or agreements of the accountholder(s) to have a specified shopping behavior. The transaction history may be determined across accounts, accountholders, financial institutions, issuers 212, acquirers 204, transaction handlers 210 or 220, or combinations thereof, for example. The targeted offer may result in an incentive that, when fulfilled, brings value to one or more of the accountholders 102 of the accounts in the account set. The targeted offers may be from any of the stakeholders 104, such as the accountholder 102, the issuer 212, the acquirer 208, the transaction handlers 216 or 220, financial institutions, or the merchant 204, or a combination thereof, for example.

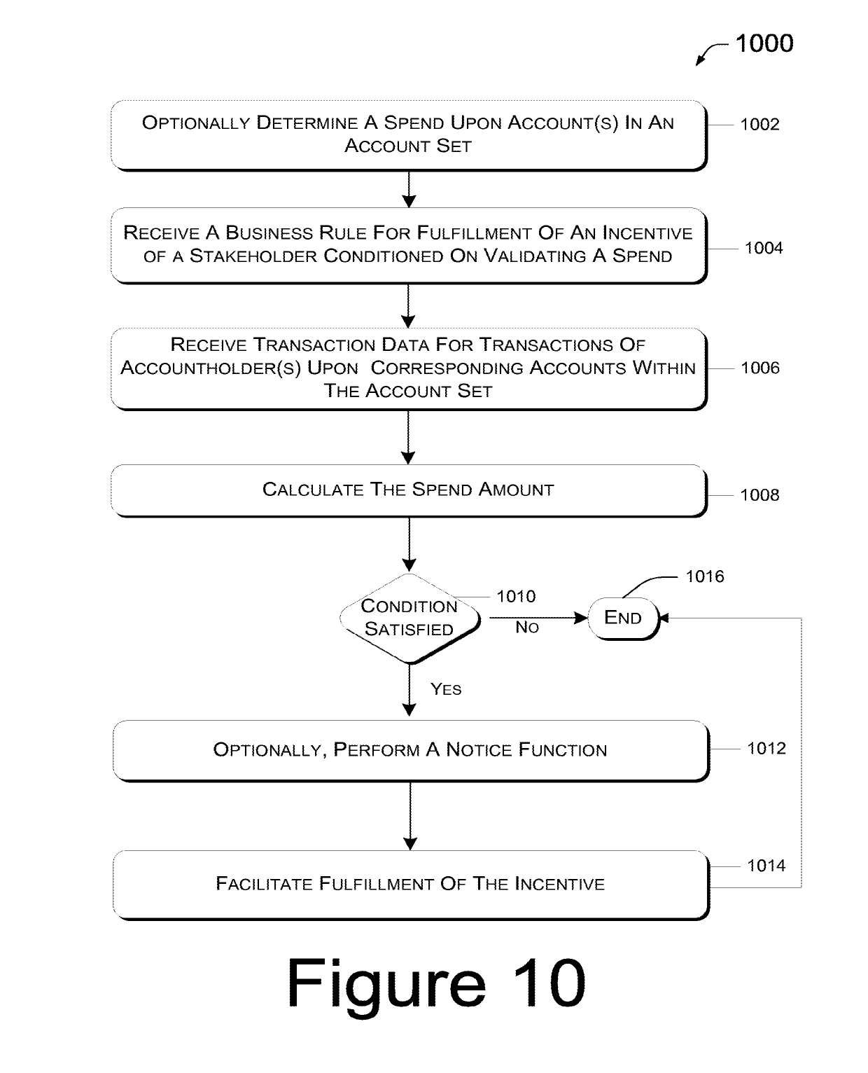

In one implementation, the fulfillment of an incentive associated with the targeted offer of the stakeholder 104 is conditioned upon validation of a spend upon accounts in an account set. Here, the transaction history of the accounts in the account set is used to validating a spend, over a duration of time, upon accounts in an account set by matching the calculated spend to a criterion. Referring to FIG. 10, a process 1000 for facilitating fulfillment of the incentive of the stakeholder 104 is depicted.

At a step 1002, the spend upon at least one account in the account set is optionally determined. The spend may be an amount of currency transferred, or to be transferred, or predicted to be transferred from at least one account in the account set. To illustrate, the first transaction handler device 216 executes code to calculate the spend as the amount of funds transferred in the last 10 transactions for footwear made payable upon either a Visa® credit account or a PayPal® account in the account set.

The spend can be calculated for transactions that are distinguished using a spend parameter. Here, the transactions have the spend parameter in common, and are, therefore distinguishable within the system 100 or the payment processing system 200. For example, transactions upon the accounts in the account set that occurred with the merchant 204, which is Starbucks® coffee shop, can be distinguished using the MCC code associated with Starbucks or another merchant identifier. Therefore, the spend parameter can be used to distinguish a set of transactions within the transaction DB 114 or 112 that have a characteristic in common, such as: an account identifier in each respective transaction data, a category for a stakeholder (e.g., MCC of the merchant 204), a routing rule that routed each respective transaction, an account feature that was applied to each respective transaction, a duration of time in which the transaction occurred, a combination thereof, or other characteristics that may be know to those of ordinary skill in the art.

In one implementation, multiple spend parameters can be used to distinguish the relevant transactions. For example, the transactions can be distinguished that occur over a duration of time and are associated with a specified stakeholder 104 or a category for the stakeholder 104. For example, if the spend parameter is a chain of banks, then the spend may be the summation of funds transferred from the accounts in the account set, over the duration of time, that were issued by any of the issuers 212 in the chain of banks.

The spend parameter may be included in, or be derivable from, the transaction data for each transaction upon the accounts in the account set. For example, the authorization request for a transaction may include an account identifier, an MCC, an issuer identifier, a UPC associated with a manufacturer, each of which may be used to distinguish the corresponding transaction as part of the spend analysis.

Referring back to FIG. 10, the spend of an accountholder with selected merchants 204 may be calculated in the step 1002. Here, the transaction data for each of the transactions stored in the transaction DB 114 may include the date of the transaction, the amount of the transaction, and a code associated with the stakeholder 104, such as merchant identifiers of the corresponding merchants 204 engaged in the respective transactions.

Thereafter, the value of the total amount of funds transferred in the distinguished transactions can be calculated. For example, each transaction amount in the distinguished transactions can be combined (e.g., $1000 was sent to Safeway Inc. Corporation in the month of May across three of the accounts of Sam Smith in the account set). Other fund transfer value calculations are also possible, such as the spend on debit accounts, the spend of a household, the spend on accounts having 4.5% Annual Percentage Rate (APR), the spend with merchants categorized in a single industry (e.g., grocery stores), or the spend accounts issued by Wells Fargo® bank, for example.

In one implementation, the spend is a ratio between a member total and a class total. Here, the member total is a combination of the transaction amounts for transactions associated with the stakeholder 104 and the class total is a combination of the transaction amounts for transactions associated with the category of the stakeholder 104 (e.g., grocery store). For example, the first transaction handler 216 may use an algorithm to determine that the member total for the transactions upon the accounts in the account set that are associated with the merchant 204 Safeway® supermarket is $10,000 for the month of march. The first transaction handler 216 may use the algorithm to also determine that the class total for the transactions upon the accounts in the account set that are associated with the category “supermarket” is $100,000 for the month of march. Therefore, the spend, here is 10% ($10000/$100000).

The spend analysis may incorporate other data that is different from the transaction data for transactions upon accounts in the account set. For example, the accountholder 102 may have indicated that Sam Smith is an accountholder of five accounts, each of which is included in the account set. Moreover, the accountholder 102 may have indicated that Sam Smith conducts 80% of the transactions of Sam Smith on the five accounts and that the other 20% of the transactions of Sam Smith is done using cash. Therefore, the spend of Sam Smith may be used to calculate the total spend of Sam Smith. Here, if the transaction history of Sam Smith for the month of March is $10000 US, then the total spend of Sam Smith for the month of March can be calculated to be $12,500 (=$10,000/0.8).

The determined spend of the step 1002 may be a predicted spend rather than an actual spend. To illustrate, the accountholder 102 may indicate that future transactions of Sam Smith upon the accounts in the account set will have a particular distribution: 100% groceries purchases will be with Safeway; or Sam Smith will utilize a Wells Fargo® credit account more than an M&I® credit account in the account set in the month of June.

In one implementation, the indicia about the determined spend may be conveyed to at least one of the stakeholders 104 interested in offering a corresponding targeted offer of an incentive. For example, indicia about the determined spend may be transmitted to the merchant 206 via an email or during an interactive electronic session wherein the merchant 206 may create targeted offers and submit them to the host 110. To illustrate, the merchant 206 may select the tool 704 from the UI 700 of the FIG. 7a and the element 714 from the UI 712 of the FIG. 7b. The merchant 206 may receive indicia about a corresponding spend of a plurality of account sets of the accountholders 102. For example, the merchant 206 may receive a report addressed from the host 110 indicating that 50 account sets in the system 100 have a spend of over $1000 US for luxury resources in the month March. The merchant 206 may utilize the received indicia to develop the targeted merchant offers (10% off of luxury items applicable toward future transactions conducted upon accounts in each of the 50 account sets) or create rules that automatically develop targeted merchant offers based on the received indicia (e.g., if an account set has a spend for luxury items that is over $1000 US in the month of March, offer 10% off of luxury items applicable toward transactions conducted with the merchant 206 in the month of April), evaluate a success of a past targeted merchant offer, or revoke a previously developed targeted merchant offer, for example.

The incentive may be conditional, wherein the incentive is eligible for fulfillment after the condition is satisfied. For example, the offer condition may be that the first transaction handler device 216 executes code to validate that the spend that actually occurred upon the accounts in the account set match a criterion (e.g., are above a threshold, meet a business rule, . . . etc.). To illustrate, the accountholder 102, Sam Smith, may have indicated that Sam Smith will utilize a Wells Fargo® credit account more than an M&I® credit account in the account set in the month of June. The Wells Fargo® issuer of the Wells Fargo® credit account may offer a 2:1 dollar to loyalty point ratio if, the actual spend on the accounts validate that Sam Smith utilizes his Wells Fargo® account more than his M&I® credit account in the month of June.

At a step 1004, a business rule is received for fulfillment of an incentive of a stakeholder 104 that is conditioned on validating the spend. For example, the first transaction handler device 216 may receive a business rule from the stakeholder 104, Safeway® supermarket. The business rule may indicate: “If 80% or more of all grocery spend upon the accounts in the account set, over a twelve month period, are with Safeway, then Safeway will give a $500 US credit to at least one accountholder 102 of an account in the set.” The host 110 may store data about the business rule in the tailoring DB 112 or 114 in association with the respective account sets.

At a step 1006, the transaction data for the transactions upon the accounts in at the account set is received. For example, the first transaction handler 210 may receive a plurality of authorization requests, authorization responses, clearing and settling requests, clearing and settling responses, batch data containing the transaction data, or combinations thereof. The transaction data may be stored in the transaction DB 114.

At a step 1008, the spend is calculated. For example, the amount of funds transferred to Safeway from the accounts in the account set for the past twelve months may be determined. Other spends can be calculated at the step 1008, as previously described.

At a step 1010 the first transaction handler device 216 executes code to determine whether the offer condition is satisfied, such as by comparing the spend with the criterion of the business rule. For example, the transaction history of the accounts in the account set for a duration of twelve months may indicate that, in fact, over 80% of grocery transactions upon the accounts in the account set occurred with Safeway, thereby satisfying the condition of Safeway's business rule. In one implementation, the determination may be made by matching the merchant identifier of Safeway, or the merchant identifiers of competitors of Safeway, to the received merchant identifiers included in the transaction data for each corresponding transaction upon the accounts in the account set. Here, if all of the grocery store transactions upon the accounts in the account set were conducted with Safeway, then it can be determined that 100% of the grocery store transactions were conducted with Safeway® grocery stores and that Safeway's condition is satisfied.

In another illustration, if the spend on the Wells Fargo® account of Sam Smith for the month of June is determined to be more than his M&I® credit account in the month of June, then the Wells Fargo® condition of the above example is determined to be satisfied.

If the condition is satisfied, the process 1000 moves from the step 1010 to a step 1012. Alternatively, the process 1000 ends at a step 1016. At the step 1012, a notice function is optionally performed. The notice may include information about the satisfaction of the offer condition, the spend of the accountholder 102 or other information pertaining to the transaction data. For example, the merchant 206 may receive a notification that for the month of June, the accountholder 102 Sam Smith has conducted 100% of the spend on groceries with Safeway. Here, the notification may be sent in a form of an electronic transmission to a computer of an agent of Safeway.

At a step 1014, fulfillment of the incentive is facilitated. To illustrate, the host 110 may calculate a credit amount that is to be applied to at least one of the accounts in the account set, based on the received Safeway business rule. Here, Safeway had offered a $500 US credit. The first transaction handler device 216 may, in turn, submit a credit request to the issuer 212 of one of the accounts in the account set to credit the corresponding account or accounts to total a $500 US credit. The first transaction handler device 216 may also submit a debit request to the acquirer 202 of Safeway for the amount of $500 US that will eventually be forwarded to the issuer(s) 212 of the account(s) that was/were credited. Other means for facilitating the application of the incentive is also applicable. For example, the host 110 may notify Safeway that one of the accountholders 102 is to receive $500 US from Safeway. Safeway may, in turn, send the accountholder 102 a check, a voucher, or Safeway gift card worth $500 towards the purchase of groceries at Safeway.

In another implementation, the fulfillment of the incentive of the targeted offer can be conditioned on validation of a change in spend. For example, the transaction handler device 216 may first confirm or validate that the transactions upon the accounts in the account set have changed such that the member total to class total spend for Safeway has increased from 50% to 80%. Thereafter, the transaction handler device 216 can facilitate the fulfilling of the $500 US credit. The process 1000 ends at the step 1016.

In another implementation, the transaction history of a plurality of accountholders 102 for the transactions upon the account in the account set is utilized to tailor merchant offers. To illustrate, the plurality of accountholders 102 may be employees of an employer. The employees of the employer may each be accountholders of personal consumer accounts (e.g., accounts issued to consumers as opposed to business accounts of the employer) issued by a plurality of issuers 212. The account set may be comprised of or comprise the consumer accounts of the employees. The employer may give each accountholder employee a code to enter when utilizing the corresponding consumer account to make business purchases, such as food purchases, associated with the employer.

The employer may analyze the transaction history of the consumer accounts of the employees. For example, the employer may query the host 110 to provide a report indicating a spend on the consumer accounts for food resources that included the code in the corresponding transaction data. The host device 116, such as the first transaction handler device 210, may filter the data in the transaction DB 114 to distinguish transactions for food resources that included the code. Here, the spend of the employees on the accounts in the account set may be determined to be $50,000 US for the past fiscal year. Thereafter, the employer may negotiate a targeted merchant offer with a particular vendor. For example, the employer may contact a retailer selling food resources (e.g., Marriott International, Inc. Corporation) and indicate that the employees of the employer spent $50,000 on food resources last year. The employer may then leverage the spend for the past fiscal year to negotiate a merchant offer (e.g., employees that purchase food from Marriott in association with the employer will receive a credit issued to their respective statements in the value of 10% of the purchase price). The employees may, in turn, purchase food from Marriott® food retailers, utilize the code of the employer during the transaction, receive the 10% credit on their respective statements from funds received from Marriott, and get reimbursed by the employer for the remaining 90% of the purchase price. In this manner, the employer saves 10% of the purchase price.

### Risk Analysis & Referral Example

In yet another implementation, the transaction data associated with transactions upon the accounts in the account set may be used to analyze risk and/or to provide referrals. Some third parties, such as landlords or potential employers, rely on referrals to determine whether to create a business relationship with a person or entity. Currently, some companies, such as credit bureaus, provide information about the reliability of an individual. However, inquiries with these entities may be costly to the inquirer; moreover, the entity may provide to the inquirer more information about the person/entity than the person/entity may want to share. Other examples of third party inquiries may include: background checks, past employment, marital status, or combinations thereof. A risk assessment algorithm may be developed to help extrapolate risk based on spend and to provide such referrals.

The transaction handler device 216 may execute a risk algorithm that calculates a risk value (e.g., a risk score). The risk value may be an assessment of whether: a specific accountholder 102 will potentially default on a loan; a specific transaction was fraudulently initiated; a likelihood that the accountholder may file bankruptcy within a specified period of time; a combination thereof; or other risk value assessments as would be known by those of ordinary skill in the art. The risk algorithm may utilize the transaction data for the transactions upon at least one account in the account set, such as those received at the step 806, to calculate the risk value based upon the transaction data for transactions across accountholders, accounts, issuers, acquirers, financial institutions, transaction handler, or a combination thereof, for example. Alternatively, or in combination, the risk algorithm may utilize data obtained from third parties. For example, the host 110 may obtain a Fair Isaac Corporation (FICO) score from a third party and utilize the FICO score in the determination of the risk value. Other risk algorithm are also applicable.

The distribution of the spend may be an input to the risk algorithm. For example, the indication of the accountholder 102 of the relationship between the spend on the accounts in the account set as compared to the total spend (cashless and cash transactions) may be used to access the accuracy of the risk value. To illustrate, the accountholder 102 may have indicated that: the distribution of the total spend of the accountholder, Sam Smith, is such that the accounts in the account set constitute 5% of the total spend of Sam Smith (the other 95% being payable by cash or upon the accounts that are not included in the account set); and that the accounts in the account set constitute 100% of the total spend of the accountholder 102, Mary Miller. Here, the accuracy of the calculated risk value based on the transaction history upon the accounts in the account set is likely more accurate for Mary Miller that of Sam Smith because 100% of the total spend of Mary Miller is upon the corresponding accounts in the account set while only 5% of the total spend of Sam Smith is upon the corresponding accounts in the account set.

In another implementation, the risk value may be used to determine whether to authorization a current transaction being processed through the system 100. For example, the host 110 may receive an authorization request for a transaction upon an account of a second transaction handler 218. The first transaction handler 210 can utilize the risk algorithm to determine the risk in authorizing the current transaction. The first transaction handler 210 may then forward, to the second transaction handler 218, the authorization request in a transmission including information based on the calculated risk value. Alternatively, the second transaction handler may instructed the first transaction handler to decline the authorization request if the risk value is past a specified threshold value and/or to submit the authorization request to a respective issuer 212 of the account upon which the current transaction is payable. In another example, the calculated risk value may be transmitted to the issuer 212 of an account in the account set with a respective authorization request.

The risk tool may be used to provide referrals to third parties. For example, an issuer may wish to determine whether to issue a debit account to the accountholder 102 of a respective account in the account set. The issuer may submit a transmission to the host 110 querying whether to issue the debit account to the accountholder 102. The host 110 may calculate the risk value based on the transaction history of the respective accounts of the accountholder in the account set. To illustrate, the transaction history of a credit account of Sam Smith in the account set may show that payments toward the balance of the charge account are often submitted late and that Sam Smith often submits the minimum payment amount required by an issuer 212 of the credit account in the account set. Here, the risk algorithm may calculate a high risk score for Sam Smith. The host 110 may then transmit a response to the issuer 212 including the risk score for Sam Smith. Alternatively, or in combination, the host 110 may provide a narrative without including the risk score, such as: “Do not issue a debit card to the accountholder.”

The accountholder 102 may create referrals and/or control the submission of referrals to such third parties, such as by using the tool 706 in the FIG. 7a. The accountholder 102 may control the distribution of referrals by creating pre-selected referrals to be submitted to referral recipients. For example, the accountholder 102 may create a report using the tool 702 in the FIG. 7a, request that the report be accessible to a referral recipient, and receive a code that the referral recipient may utilize to access the created report. The referral code can then be given to the referral recipient. The referral recipient may then access the system 100, such as by connecting to the host via the network 106 or the network 108. The referral recipient may, in turn, enter the referral code, such as by entering it into a UI data entry form. The host 110 may then retrieve the report and submit it to the referral recipient. To illustrate, the accountholder 102 may create a report (tool 702 in the FIG. 7a) including an analysis of the transaction history of the accounts of the accountholder 102 in the account set and indicating that the accountholder 102 has a low risk score. The accountholder 102 may then use the referral tool, such as tool 706, to associate the created report with a referral access code. The accountholder 102 may give the referral access code to a first issuer. The first issuer may, in turn, utilize the corresponding referral access code to access the created report, such as entering the referral access code into a data entry form at a webpage managed by the host 110 or an agent of the host 110. Here, the accountholder 102 may want to provide the issuer access to the created report in order to apply for an upgrade to the account of the accountholder 102 issued by the first issuer. In another illustration, the accountholder 102 may create a report analyzing the transactions of the accountholder 102 upon the account(s) of the accountholder 102 in the account set for pharmaceutical resources. The accountholder 102 may then use the tool 602 to give access to the pharmaceutical resources report to the accountant of the accountholder 102 for tax purposes.

The accountholder 102 may control the distribution of referrals by imposing restrictions on the submission of the referrals that are unsolicited by the accountholder 102 or are requested by referral recipients. For example, the accountholder 102 may indicate who may receive referrals; what data may be conveyed in a referral; how the referral may be sent to the recipient of the referral, such as by indicating that the accountholder 102 should be notified of a potential referral submission and the referral only be sent if the accountholder 102 confirms the submission; or a combination thereof. For example, the accountholder 102 may utilize the tool 706 in FIG. 7a to access a UI wherein the accountholder 102 may enter data into a data entry form. The accountholder 102 may delineate the restrictions or access rights that are then saved in the tailoring DB 112. Thereafter, the host 110 may utilize the referral restrictions or access rights to determine how to process a referral. To illustrate, the accountholder 102 may indicate that: no referrals should be sent to any credit card issuers, no numerical data should be sent to landlords, only FICO scores that are above a threshold limit be conveyed to financial institutions, or that the accountholder 102 receive an alert when a potential employer of the accountholder 102 submits a request for a referral.

In another implementation, the referral may be provided to individuals or entities considering doing business with one of the accountholders 102 of one of the accounts in the account set. To illustrate, the accountholder 102 may wish to rent an apartment from a landlord. Rather than submitting a social security number to the landlord for the landlord to conduct a background check, the accountholder 102 may submit a referral code to the landlord. The landlord, in turn, may submit a referral request including the referral code to the host 110, for example via a UI of a website. The host 110 may utilize the risk algorithm to determine the risk value associated with the accountholder 102. The host 110 may transmit a referral response to the request including data based on the determined risk value. The transmission may be sent to the landlord, such as by rendering the report on the UI of a website.

### Purchased Resource Related Services Example

In yet a further implementation, the transaction history of the transactions upon the account(s) in the account set may be used to provide purchased resource related services (e.g., tool 708 of the FIG. 7a). The transaction data of the corresponding transactions upon the accounts in the account set, such as data stored in the transaction DB 114, may include information about the resources purchased in the corresponding transaction. The information about the resources purchased may include: the resource identifier, such as the UPC; a Stock Keeping Unit (SKU); a resource description (Red Prada strapless shoes with 3 inch heel shown in Milan Fashion Show 2007); a weight of the resource purchased; other data usable to distinguish the resource in the system 100; warranty information, such as the a warranty duration, an address to report disputes, or information that may have been provided by the accountholder 102 that purchased the resource, the merchant 206 that sold the resource, the manufacturer that made the resource, any third party having the warranty information, or a combination thereof; consumer reports on the performance of the resource, such as those provided by a consumer group; resource recalls or alerts about the safety of the resource, such as those publicly disclosed by the merchant 206 that sold the resource, the manufacturer that made the resource, an agency (e.g., Federal, public or private), or a combination thereof; or any other information about the resource that can be accessed and entered into a database, such as the transaction DB 114.

The information in the transaction data about the resources purchased may be utilized to provide purchased resource services, such as providing a notification function. For example, if the warranty information for a resource purchased by one of the accountholders 102 indicates that the warranty on the purchased resource is about to expire, the host 110 or an agent of the host 110, may send a notification to the accountholder 102 that purchased the resource indicating that the warranty is about to expire. Alternatively, or in combination if the purchased resource has been recalled, the accountholder 102 that purchased the recalled resource may receive a notification indicating that the recalled resource has been recalled.

To illustrate, in the above “Exemplary Application of Routing Rules In Real-Time” example, the transaction handler device 216 may use a look up table to compare the received indicator of the good or product in the authorization request with an indicator store in the DB 112 or DB 114 to find a match. The indicator stored in the DB 112 or DB 114 may be associated with a communication from the corresponding manufacturer of the product. The notification function may include notifying at least the consumer engaged in the transaction or an accountholder 102 of one of the accounts in the account set of the manufacturer's communication associated with the matched product.

In another implementation, the accountholder Sam Smith may have purchased a Honda® vehicle payable upon a loan account issued by a bank. The host 110 may have received the transaction data for the purchase including the resource indicator of the Honda® vehicle. The host 110 may, in turn, query Honda Motor Co. for details about a two-year warranty on the Honda® vehicle, such that the query references the resource indicator of the Honda® vehicle. The host 110 may, in turn, pre-populate a warranty card for Sam Smith to review and submit the reviewed warranty card to the Honda® manufacturer. Important dates may be docketed such that the host 110 and/or Sam Smith receives an automatic alert about upcoming deadlines one month prior to the passage of the two-years. The host 110 may have also received, from the manufacturer, data for intermittent vehicle maintenance service for the Honda® vehicle (e.g., date of an oil change) that may occur during the two-years after the purchase. For example, the transaction DB 114 may include the transaction data for the transactions of the manufacturer paying for the regular maintenance service for the Honda® vehicle. Thereafter, one month prior to the two-year anniversary of the purchase of the Honda® vehicle, the host 110 may send a notification to Sam Smith indicating that the warranty on the Honda® vehicle is about to expire. Moreover, based on the data on the regular maintenance service, the host 110 may indicate that the Honda® vehicle is due for another oil change.

In another illustration, the purchase resource may be a plasma television with a known weight. The accountholder that purchased the plasma television may receive the notification that the warranty on the plasma television is about to expire. The corresponding accountholder 102 may send a communication to the host 110, such as by using the tool 708 in the FIG. 7a, to indicate that the corresponding accountholder would like to return the plasma television to the manufacturer. The host 110, or an agent of the host 110, may then send a pre-addressed, postage paid box to the corresponding accountholder 102 to facilitate the return. The postage may be calculated from the transaction data stored in the transaction DB 114. For example, the host 110 may have received a manufacturer resource return address from the manufacturer when the warranty information was submitted to the host 110. The host 110 may also know the address of the corresponding accountholder 102 that purchased the plasma television, such as by the corresponding accountholder 102 entering the respective address while using the tool 608. Alternatively, or in combination, the host 110 may predict the address from the billing address of the corresponding accountholder 102, the location of the merchant 206 from which the plasma television was purchased, the delivery address associated with the purchase, or by other means as known by those of ordinary skill in the art. The host 110, may in turn, determine the current shipping costs for the known weight of the plasma television and the known distance traveled, prepare the postage paid box and charge one of the accounts in the account set of the corresponding accountholder 102 for the postage of the box.

It should be understood that the present invention can be implemented in the form of control logic, in a modular or integrated manner, using software, hardware or a combination of both. The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods to implement the present invention.

It is understood that the examples and implementations described herein are for illustrative purposes only and that various modifications or changes in light thereof will be suggested to persons skilled in the art and are to be included within the spirit and purview of this application and scope of the appended claims.

What is claimed is:

1. A computer-implemented method, comprising:
providing a computing apparatus including:
a transaction handler configured on an electronic processing network in which the transaction handler interconnects first processors and second processors in processing of electronic transactions,
at least one database coupled with the transaction handler, and
a communication portal coupled with the at least one database and the transaction handler and connected to communicate outside the electronic processing network;
providing, by the communication portal, a user interface;
linking, based on input received from a first user, via the user interface, a plurality of accounts to a first identifier for an account set;
storing the first identifier in the at least one database;
receiving, via the user interface, rules for routing transactions in the processing network, and criteria for electronic transmissions to users;
storing the rules in the at least one database in association with the first identifier;
during processing of a transaction for a second user at a transaction terminal, automatically causing, as controlled by the rules, a display to the second user at the transaction terminal, and receiving a selection of the second user from the display of a first electronic account that is linked to the first identifier for use by the transaction handler in the processing;
processing, by the transaction handler, as configured by the rules, the transaction using the first electronic account, the processing comprising receiving a second identifier of the second user from the transaction terminal, and submitting a query to the at least one database to access the first identifier for comparison to the second identifier;
accessing, in the at least one database, prior transactions in the processing network to determine an occurrence of a predefined event associated with the rules, the determining comprising comparing a sum of values for transactions in the processing network associated with the first user to a sum of values for transactions in the processing network associated with users other than the first user;
in response to the occurrence of the predefined event:
selecting, based on the rules, a second electronic account of the first user from the account set,
processing an addition of a value to the second electronic account, and
transmitting an alert, as defined by the criteria for electronic transmissions, to a computing device of the first user to cause display of the value to the first user.

2. The computer-implemented method of claim 1, wherein the at least one database comprises a tailoring database storing the rules.

3. The computer-implemented method of claim 1, wherein the at least one database comprises a transaction database storing the prior transactions.

4. The computer-implemented method of claim 1, further comprising receiving, by the transaction handler, an authorization request from the transaction terminal, the authorization request including the second identifier.

5. The computer-implemented method of claim 4, further comprising routing the authorization request to an issuer processor in the processing network, and receiving an authorization response from the issuer processor.

6. The computer-implemented method of claim 5, wherein the processing the addition of the value to the second electronic account comprises sending a transmission to the issuer processor to cause the addition.

7. The computer-implemented method of claim 6, further comprising in response to receiving the authorization response, forming a transmission for delivery to the transaction terminal, the delivery including the authorization response.

8. The computer-implemented method of claim 1, wherein the account set comprises an account associated with a first issuer processor in the processing network and a different account associated with a second issuer processor in the processing network.

9. The computer-implemented method of claim 1, wherein the account set comprises an account associated with the transaction handler and a different account associated with a different transaction handler in the processing network.

10. The computer-implemented method of claim 1, further comprising receiving, by the transaction handler, an authorization request from the transaction terminal, and routing the authorization request from the transaction handler to a destination transaction handler in the processing network that is configured to forward the authorization request to an issuer processor.

11. The computer-implemented method of claim 1, wherein the account set comprises a plurality of accounts each associated with a respective transaction terminal.

12. The computer-implemented method of claim 1, further comprising receiving, from the transaction terminal, a code that identifies the transaction terminal.

13. The computer-implemented method of claim 1, wherein the user interface is provided via a website hosted by the communication portal.

14. The computer-implemented method of claim 1, further comprising receiving a user identifier from the computing device of the first user, and retrieving, from the at least one database, a profile corresponding to the account set.

15. A computer system, comprising:
at least one database;
a transaction handler, coupled with the at least one database, configured on an electronic processing network in which the transaction handler interconnects first processors and second processors in processing of electronic transactions, wherein the transaction handler is configured to process, as configured by rules for routing transactions in the processing network, a transaction using a first electronic account that is linked to a first identifier for an account set, the processing comprising receiving a second identifier of a second user from a transaction terminal, and submitting a query to the at least one database to access the first identifier for comparison to the second identifier;
a communication portal coupled with the at least one database and the transaction handler and connected to communicate outside the electronic processing network, the portal configured to provide a user interface;
at least one processor, coupled to the transaction handler; and
memory storing instructions configured to instruct the at least one processor to:
link, based on input received from a first user, via the user interface, a plurality of accounts to the first identifier;
store the first identifier in the at least one database;
receive, via the user interface, the rules for routing transactions, and criteria for electronic transmissions to users;
store the rules in the at least one database in association with the first identifier;
during processing of the transaction for a second user at a transaction terminal, automatically cause, as controlled by the rules, a display to the second user at the transaction terminal, and receive a selection of the first electronic account by the second user from the display;
access, in the at least one database, prior transactions in the processing network to determine an occurrence of a predefined event associated with the rules, the determining comprising comparing a sum of values for transactions in the processing network associated with the first user to a sum of values for transactions in the processing network associated with a plurality of users other than the first user;
in response to the occurrence of the predefined event:
select, based on the rules, a second electronic account of the first user from the account set,
process an addition of a value to the second electronic account, and
transmit an alert, as defined by the criteria for electronic transmissions, to a computing device of the first user to cause display of the value to the first user.

16. The computer system of claim 15, wherein the at least one database comprises a tailoring database storing the rules and a transaction database storing the prior transactions.

17. The computer system of claim 15, wherein the instructions are further configured to instruct the at least one processor to receive a user identifier from the computing device of the first user, and retrieve, from the at least one database, a profile corresponding to the account set.

18. The computer system of claim 15, wherein the transaction handler is further configured to receive an authorization request from the transaction terminal, the authorization request including the second identifier.

19. The computer system of claim 15, wherein the instructions are further configured to instruct the at least one processor to send a transmission to an issuer processor to cause the addition of the value to the second electronic account.

20. The computer system of claim 15, further comprising a destination transaction handler, and wherein the transaction handler is further configured to receive an authorization request from the transaction terminal, and route the authorization request to the destination transaction handler to cause forwarding of the authorization request to an issuer processor in the processing network.
